(19) United States
(12) Patent Application Publication
(10) Pub. No.: US 2026/0073721 A1
(43) Pub. Date: Mar. 12, 2026

(54) REMOTE CHECK DEPOSIT IMAGE ENHANCEMENT

(71) Applicant: Capital One Services, LLC, McLean, VA (US)

(72) Inventor: Amith Kumar RAMACHANDRAN, Brunswick, NJ (US)

(73) Assignee: Capital One Services, LLC, McLean, VA (US)

(21) Appl. No.: 18/828,554

(22) Filed: Sep. 9, 2024

(51) Int. Cl. G06V 30/10; G06T 3/40; G06T 9/00; G06V 10/771

(52) U.S. Cl. CPC G06V 30/10; G06T 3/40; G06T 9/00; G06V 10/771

(57) ABSTRACT

A computer implemented method, system, and non-transitory computer-readable device for a remote deposit environment. In some embodiments, an autoencoder machine learning (ML) model may be trained to enhance an image and increase the resolution of the image for subsequent OCR processing. The autoencoder ML model may be invoked following a failed OCR processing or a prediction that an OCR processing is likely to fail, increasing the data extraction capabilities of the remote deposit environment on images that were previously unable to be processed. In some embodiments, the autoencoder ML model may be implemented on a mobile device. In some embodiments, the remote deposit environment may preprocess the image using a machine learning model trained to determine an image readability before applying the autoencoder ML model.

### BACKGROUND

As technology evolves, institutions have found ways to make digital document processing more convenient. For example, in the financial industry, mobile banking apps may let you deposit paper checks or other financial instruments from virtually anywhere using a smartphone or tablet. Additionally, institutions may allow remote verification of identification documents to allow access to a service, product, and/or website. However, the accuracy of document intake systems heavily rely on the quality of the input documents. For example, in the financial industry, low-resolution or blurry images may cause optical character recognition (OCR) systems to fail. This may lead to inaccurate deposit data extraction and result in processing delays and financial losses.

### BRIEF DESCRIPTION OF THE DRAWINGS

The accompanying drawings are incorporated herein and form a part of the specification.

FIG. 1 illustrates an example remote deposit financial instrument capture, according to some embodiments.

FIG. 2 illustrates example remote deposit OCR segmentation, according to some embodiments.

FIG. 3 illustrates an example block diagram of a remote deposit system architecture, according to some embodiments.

FIG. 4 illustrates an example flow diagram of a remote deposit system, according to some embodiments.

FIG. 5 illustrates an example block diagram of a client computing device, according to some embodiments.

FIG. 6 illustrates an example flow diagram of a machine learning (ML) training pipeline, according to some embodiments.

FIG. 7 illustrates an example flow diagram of an ML inference, according to some embodiments.

FIG. 8 illustrates an example flow diagram of a method, according to some embodiments.

FIG. 9 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method and/or computer program product embodiments, and/or combinations and sub-combinations thereof for implementing an image enhancement system, which may assist, in real-time, a customer electronically depositing a financial instrument, such as a check. In the event of a failed optical character recognition (OCR) process, the image enhancement system may be used to increase the likelihood that the associated image will be successfully processed via a subsequent OCR to obtain deposit data. OCR is the electronic or mechanical conversion of images of typed, handwritten or printed text into machine-encoded text, whether from a scanned document, a photo of a document, a scene photo, stream of image data, etc. Utilizing OCR, data (e.g., check amount, signature, MICR line, account number, etc.) may be extracted from one or more images of a check and used to process a remote deposit. In some embodiments, image enhancement may involve increasing the resolution of an image to produce a higher resolution image. In some embodiments, image enhancement may involve removing noise from the pixel data of an image.

Mobile check deposit is a fast, convenient way to deposit funds using a customer’s mobile device or laptop. As financial technology and digital money management tools continue to evolve, the process has become safer and easier than ever before. Mobile check deposit is a way to deposit a financial instrument, e.g., a paper check, through a banking app using a smartphone, tablet, laptop, etc. Currently, mobile deposit allows a bank customer to capture a picture of a check using, for example, their smartphone or tablet camera and upload it through a mobile banking app running on the mobile device. Deposits commonly include personal, business or government checks.

Most banks and financial institutions use advanced security features to keep an account safe from fraud during the mobile check deposit workflow. For example, security measures may include encryption and device recognition technology. In addition, remote check deposit apps may capture check deposit information without storing the check images on the customer’s mobile device (e.g., smartphone). Mobile check deposit may also eliminate or reduce typical check fraud as a thief of the check may not be allowed to subsequently make use of an already electronically deposited check, whether it has cleared or not, as remote deposit systems may provide an alert to the banking institution of a second deposit attempt. In addition, fraud controls may include mobile security alerts, such as mobile security notifications or SMS text alerts, which can assist in uncovering or preventing potentially fraudulent activity.

Currently, computer-based (e.g., laptop) or mobile-based (e.g., mobile device) technology allows a customer to initiate a document uploading process for uploading images or other electronic versions of a document to a backend system (e.g., a document processing system) for various purposes. In some cases, this technology does not or cannot sufficiently assess, prior to upload and/or further processing, whether images of documents will be able to be successfully processed at the backend system. For example, in some cases, this technology does not or cannot assess, prior to upload and/or further processing, whether images of documents will be able to be successfully processed using OCR to extract data necessary to complete deposits for the customer. Currently, image capture problems may be revealed by cancellations or additional requests to recapture images of the check after an OCR processing attempt, or a customer taking their deposit to another financial institution, causing a potential duplicate presentment fraud issue.

The restrictive approach of current systems is necessitated in certain document upload processes because such processes have automated routines for receiving the images, processing the images, and completing actions associated with the upload of the images. For example, a customer may utilize a mobile deposit application to upload an image of a document associated with a customer account, such as a check associated with the customer’s bank account. Once initiated, the document upload and processing may continue until the image has been processed, either successfully or unsuccessfully, without any further input from the customer. This current approach is problematic because the customer is typically not given any information about the status of the image until after the process has completed, when it is too late to cancel or correct the upload and time and processing costs have been wasted.

These processes are more likely to cause increased error rates, processing costs, and customer frustration. The more accurately technology can determine, prior to or during upload and/or an OCR processing attempt, whether an image will be acceptable for processing a financial transaction, the more efficient and seamless the customer experience will be, and the fewer system and network resources will be required (such as memory space for storing images, processing time associated with processing invalid images, including OCR processing, and network resources associated with sending and receiving invalid images). For example, enhancing an image resulting from an unsuccessful OCR may prevent a customer from being required to capture another picture. Accordingly, transaction processing delays may be reduced. Further, processing costs at the backend system may be reduced by enhancing an image resulting from an unsuccessful OCR, as the backend system may be less burdened with performing repeated OCR processing attempts on the initial image, rejecting unusable images, communicating with a remote device to initiate image recapture, etc.

While existing processes (e.g., document alignment guides, instructions to hold a camera still while capturing an image, etc.) can provide some guard against the capture and upload of unacceptable images, the systems and methods disclosed herein may result in higher rates of successful OCR processing, leading to a more seamless customer experience and reduced subsequent processing costs, both at the customer’s computing device and at the bank’s backend system. In some embodiments, acceptability of an image refers to whether the image can be processed to extract data from the image (e.g., via OCR) that is necessary for processing a transaction (e.g., a remote deposit). In some embodiments, acceptability of an image may also refer to whether the image will pass various image quality checks (e.g., lighting checks, positioning checks, completeness checks, etc.) performed in existing remote deposit systems post image capture.

The technology described herein in the various embodiments implements a system for enhancing images in response to a failed OCR to increase the likelihood of a successful subsequent OCR to extract deposit data. In some embodiments, an image may be enhanced straightaway after a failed OCR attempt. After enhancing the image, a subsequent OCR attempt may have an increased likelihood of success. However, not all failed OCR processes are equal. As such, it may be helpful to identify two categories of failed OCR attempts: a readable image and an unreadable image. In the first readable category, the OCR has failed to extract the relevant data fields, but the image still contains sufficient structure or patterns within, so that data extraction is still possible. For example, this category may include images that failed OCR but can still be read by a human eye or be successfully sharpened by an image enhancement process. In the second unreadable category, the OCR has failed to extract the relevant data fields, but the image does not contain any useful information where any enhancing would help. The system may aim to remedy the first readable category of failed OCR images and apply an image enhancing process so a subsequent OCR may be successful.

Thus, in some embodiments the image that failed OCR may be assessed using an ML model operating on a customer’s mobile device (e.g., a mobile phone) to determine if the image meets a threshold level of readability. When the image meets a threshold level of readability, the system may proceed with the image enhancement process. When the image does not meet a threshold level of readability, the system may prompt a user to recapture the image. In some embodiments, the ML model may be trained using supervised or semi-supervised learning, for example, by providing a collection of categorized images (e.g., readable/unreadable images that have failed OCR) of checks to an untrained or partially trained model to train a predictive ML model (e.g., a classification model and/or regression model). Upon being provided an image of a check, the predictive ML model may be configured to provide a likelihood the check image will be successfully processed via OCR (e.g., a confidence score). Using the confidence score or other indication of the likelihood from the predictive ML model, a mobile banking app operating on the customer’s mobile device may provide an image readability status to the customer via a user interface (UI). Accordingly, the predictive ML model may be able to assess check images mid-experience. Implementing the technology disclosed herein, an image readability status may be rendered on a UI mid-experience. This additional readability check may provide substantial decreases in processing time and wasted resources, ensuring that the system only performs image enhancements on images that first meet a certain level of readability.

In some embodiments, the image enhancing process may also be applied to an image before any OCR process is conducted. If the required processing time and resources of the image enhancing process are relatively low in comparison to the OCR process, the likelihood of a successful initial OCR may be increased without introducing too much overhead.

In some embodiments, the image being assessed may be an image that has been captured by a camera of the customer’s mobile device and stored within memory of the mobile device, either in permanent storage or temporary storage such as an image buffer. In some embodiments, the image being assessed may be an image frame that is part of a stream of live or continuously observed imagery. This imagery may be processed continuously, for example, in real-time, using the predictive ML model without first storing an image in permanent memory (or perhaps additionally without storing an image in an image buffer). In such alternative embodiments, the assessment of the image frame may be used to trigger automatic capture and at least temporary storage of the image frame. In some embodiments, live camera imagery may be streamed as encoded data configured as a byte array (e.g., as a Byte Array Output Stream object). The byte array may be a group of contiguous (side-by-side) bytes, for example, forming a bitmap image. This local processing solution may eliminate or reduce image storage requirements for image assessment using an ML model.

While described throughout for image assessment performed on the client device, in some embodiments, the image or live stream of imagery may be communicated to one or more remote computing devices or cloud-based systems for performing a remote image assessment, wherein the predictive ML model operates on the one or more remote computing devices or cloud-based systems. In such embodiments, the predictive ML model may still determine a likelihood of successful OCR processing prior to forwarding an image for further processing. In such embodiments, an image readability status may also be provided to a customer in real-time via a UI.

ML involves computers discovering how they can perform tasks without being explicitly programmed to do so. ML may include, but is not limited to, artificial intelligence, deep learning, fuzzy learning, supervised learning, unsupervised learning, etc. Machine learning algorithms may build a model based on sample data, known as “training data,” in order to make predictions or decisions without being explicitly programmed to do so. For supervised learning, the computer may be presented with example inputs and their desired outputs and the goal is to learn a general rule that maps inputs to outputs. In another example, for unsupervised learning, no labels may be given to the learning algorithm, leaving it on its own to find structure in its input. Unsupervised learning can be a goal in itself (discovering hidden patterns in data) or a means towards an end (feature learning).

A machine learning engine (e.g., operating on ML platform 329) may use various classifiers to map concepts associated with a specific image capture/OCR process to capture relationships between concepts (e.g., device movement data vs. OCR processing success). The classifier (discriminator) may be trained to distinguish (recognize) variations. Different variations may be classified to ensure no collapse of the classifier and so that variations can be distinguished.

In some embodiments, machine learning models may be trained on a remote machine learning platform (e.g., ML platform 329) using other customer’s transactional information (e.g., previously submitted deposit check images and OCR processing results). In addition, large training sets of the other customer’s historical information may be used to normalize prediction data (e.g., not skewed by a single or few occurrences of a data artifact). Thereafter, predictive ML model(s) may assess a specific deposit check image against the trained predictive model to predict whether image quality is sufficient to complete OCR processing. In some embodiments, the predictive ML model(s) may be continuously updated as new financial transactions occur.

In some embodiments, a ML engine may continuously change weighting of model inputs to increase accuracy of the predictive ML model(s). For example, weighting of specific data fields may be continuously modified in the model to trend towards greater accuracy, where accuracy is recognized by correct predictions of whether a deposit check image will be successfully processed via OCR. Conversely, term weighting that lowers accuracy may be lowered or eliminated.

In some embodiments, the ML engine may operate on, and machine learning models may be trained on, a mobile machine learning platform (e.g., mobile ML platform 310). In such embodiments, the machine learning models may be trained on a single customer’s transactional information (e.g., previously submitted deposit check images and OCR processing results).

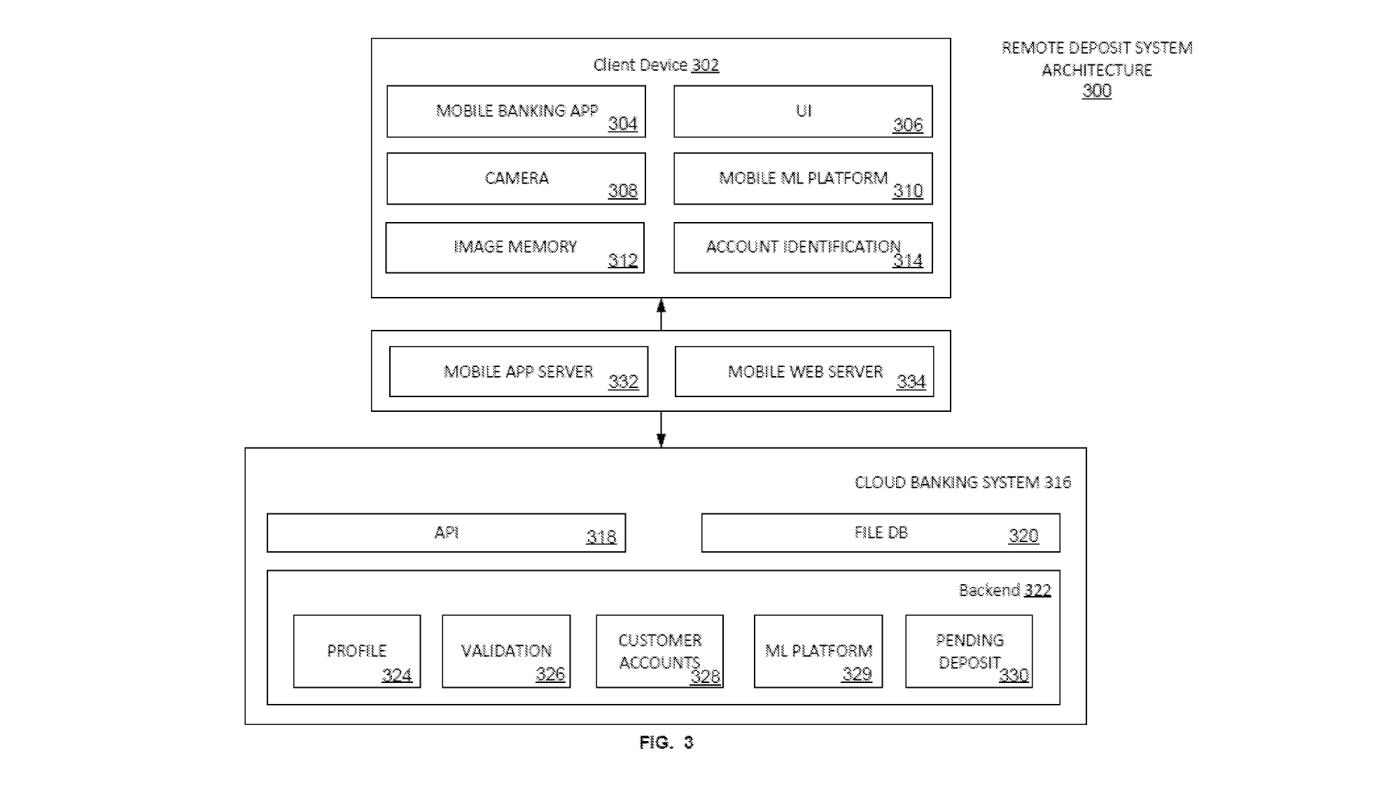

Various embodiments of this disclosure may be implemented using and/or may be part of a remote deposit system shown in FIGS. 3-5. It is noted, however, that this environment is provided solely for illustrative purposes, and is not limiting. Embodiments of this disclosure may be implemented using and/or may be part of environments different from and/or in addition to the remote deposit system, as will be appreciated by persons skilled in the relevant art(s) based on the teachings contained herein.

Variations of the devices disclosed herein are contemplated. For example, in a computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user’s environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

In one non-limiting example, OCR processes may benefit from image object builds generated by one or more, or a combination of cameras or lenses. For example, multiple cameras or lenses may separately, or in combination, capture specific blocks of imagery for data fields located within a document that is present, at least in part, within the field of view of the cameras. In another example, multiple cameras or lenses may capture more light than a single camera or lens, resulting in better image quality. In another example, individual lenses, or a combination of lenses, may generate depth data for one or more objects located within a field of view of the camera.

An example of the remote deposit system shall now be described.

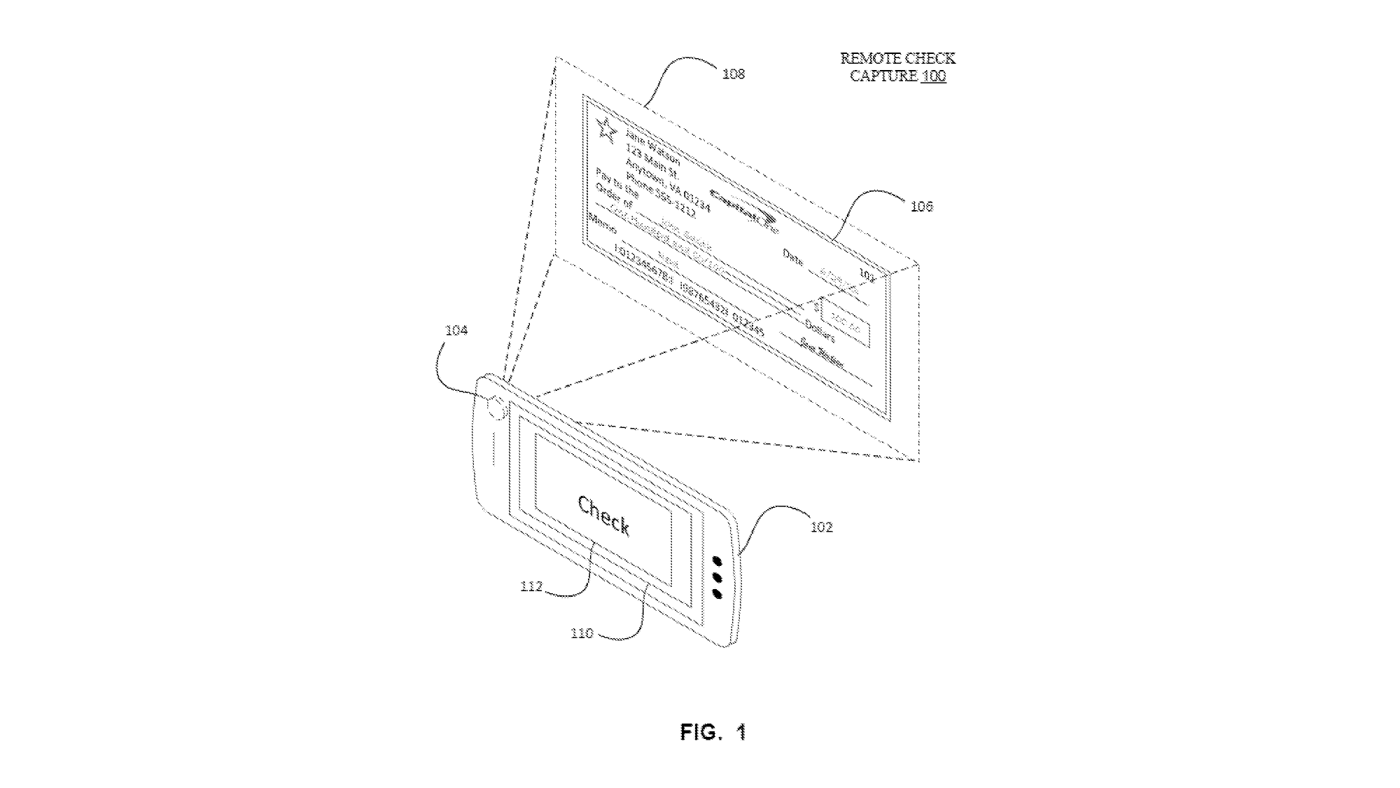

FIG. 1 illustrates an example remote financial instrument capture 100, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Financial instrument 106 may be a personal check, a business check, a cashier’s check, a certified check, a traveler’s check, a treasury check (i.e., a government check), a payroll check, or a money order, to name a few. In some embodiments, a customer may initiate a remote deposit financial instrument capture from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc., may be substituted without departing from the scope of the technology disclosed herein. For example, when the document to be deposited is a personal check, the customer may select a customer account at the bank account (e.g., checking or savings) into which the funds specified by the check are to be deposited. Content associated with the document may include the funds or monetary amount to be deposited to the customer account, the issuing bank, the routing number, and the account number. Content associated with the customer account may include a risk profile associated with the account and the current balance of the account. Options associated with a remote deposit process may include continuing with the deposit process or cancelling the deposit process, thereby cancelling depositing the check amount into the account.

Mobile computing device 102 may communicate with a bank or third party using a communication or network interface (not shown). Communication interface may communicate and interact with any combination of external devices, external networks, external entities, etc. For example, communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device via a communication path that includes the Internet.

In an example approach, a customer may login to their mobile banking app, select the account they want to deposit a financial instrument into, then select, for example, a “deposit check” option that will activate their mobile device’s camera 104 (e.g., activate the camera). One skilled in the art would understand that variations of this approach or functionally equivalent alternative approaches may be substituted to initiate a mobile deposit.

Using the camera 104 function on the mobile computing device 102, the customer may capture live imagery from a field of view 108 that includes at least a portion of one side of a financial instrument 106. Typically, the camera’s field of view 108 will include at least the perimeter of the financial instrument 106. However, any camera position that generates in-focus financial instrument imagery 112 of the various data fields located on a financial instrument may be considered. Resolution, distance, alignment, and lighting parameters may require movement of the mobile device until a proper view of a complete financial instrument, in-focus, has occurred. An application running on the mobile computing device 102 may offer suggestions or technical assistance to guide a proper framing of a financial instrument within the mobile banking app’s graphically displayed field of view window 110, displayed on a User Interface (UI) instantiated by the mobile banking app. A person skilled in the art of remote deposit would be aware of common requirements and limitations and would understand that different approaches may be required based on the environment in which the financial instrument viewing occurs. For example, poor lighting or reflections may require specific alternative techniques. As such, any known or future viewing or capture techniques are considered to be within the scope of the technology described herein. Alternatively, the camera may be remote to the mobile computing device 102. In an alternative embodiment, the remote deposit may be implemented on a desktop computing device with an accompanying digital camera.

Sample customer instructions may include, but are not limited to, “Once you’ve completed filling out the check information and signed the back, it’s time to view your check,” “For best results, place your check or money order on a flat, dark-background surface to improve clarity,” “Make sure all four corners of the check fit within the on-screen frame to avoid any processing holdups,” “Select the camera icon in your mobile app to open the camera,” “Hold the camera still,” “Once you’ve viewed a clear image of the front of the check or money order, repeat the process on the back of the check or money order,” “Do you accept the funds availability schedule?” “Swipe the Slide to Deposit button to submit the deposit,” “Your deposit request may have gone through, but it’s still a good idea to hold on to your check for a few days,” “Keep the check or money order in a safe, secure place until you see the full amount deposited in your account,” and “After the deposit is confirmed, you can safely destroy the check.” These instructions are provided as sample instructions or comments but any instructions or comments that guide the customer through a remote deposit session may be included.

In a non-limiting example, live streamed image data captured using camera 104 may be assembled into one or more frames of image content. In some embodiments, a data signal from a camera sensor (e.g., CCD) may notify the banking app when an entire sensor has been read out as streamed data. In this approach, the camera sensor may be cleared of electrons before a subsequent exposure to light and a next image frame is captured. This clearing function may be conveyed to the mobile banking app, and/or a ML framework operating on mobile computing device 102, to indicate that the Byte Array Output Stream object constitutes a complete frame of image data. In some embodiments, the images formed into a byte array may be first rectified to correct for distortions based on an angle of incidence, may be rotated to align the imagery, may be filtered to remove obstructions or reflections, and may be resized to correct for size distortions using known image processing techniques. In some embodiments, these corrections may be based on recognition of corners or borders of the financial instrument as a basis for image orientation and size, as is known in the art.

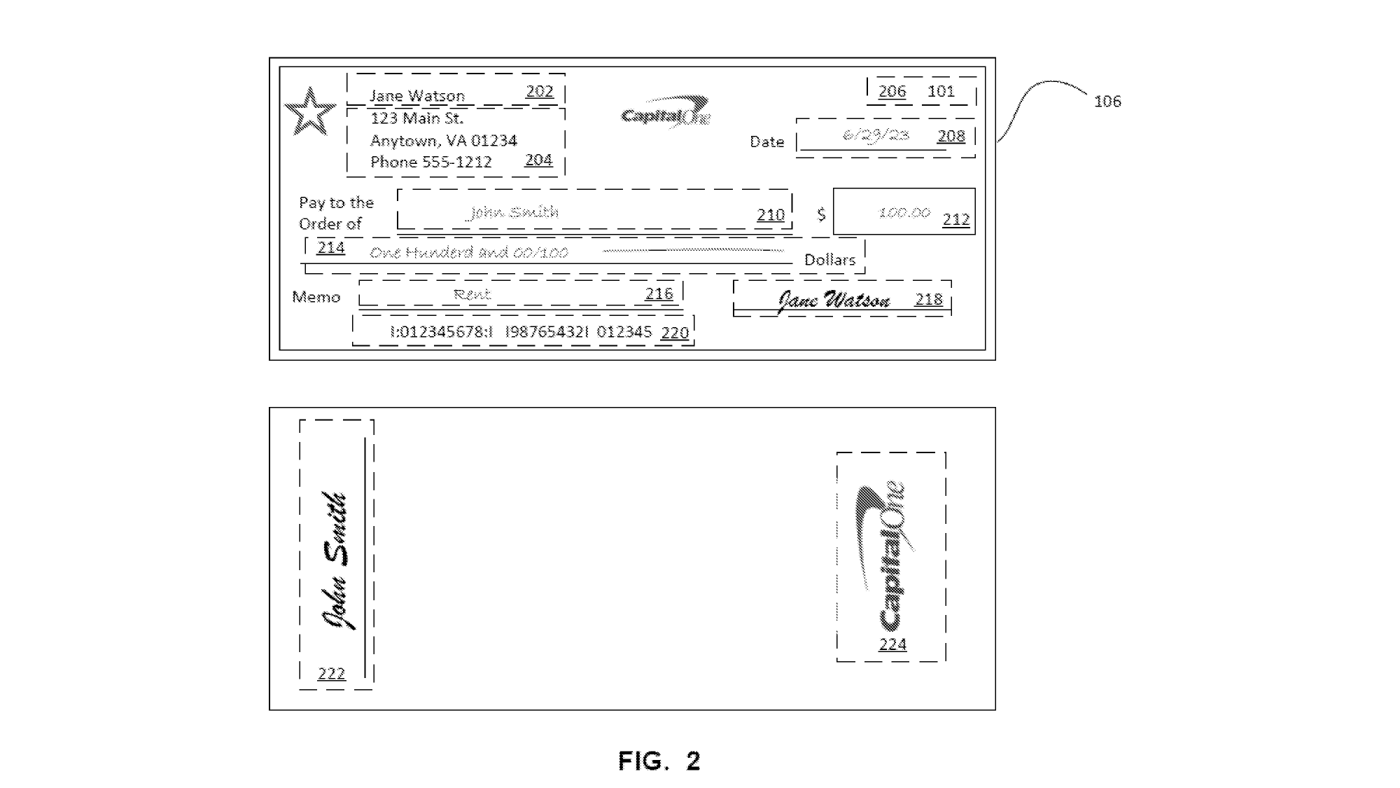

FIG. 2 illustrates example remote deposit OCR segmentation, according to some embodiments. Depending on financial instrument type, a financial instrument may have a fixed number of identifiable fields. For example, a financial instrument may have front side fields, such as, but not limited to, a payer customer name 202 and address 204, check number 206, date 208, payee field 210, payment amount 212, a written amount 214, memo line 216, Magnetic Ink Character Recognition (MICR) line 220 that includes a string of characters including the bank routing number, the payer customer’s account number, and the check number, and finally the payer customer’s signature 218. Back side identifiable fields may include, but are not limited to, payee signature 222 and security fields 224, such as a watermark.

While a number of fields have been described, it is not intended to limit the technology disclosed herein to these specific fields as a check or other financial instrument may have more or less identifiable fields than disclosed herein. In addition, security measures may include alternative approaches discoverable on the front side or back side of the financial instrument or discoverable by processing of identified information. For example, the remote deposit feature in the mobile banking app running on the mobile computing device 102 may determine whether the payment amount 212 and the written amount 214 are the same. Additional processing may be needed to determine a final amount to process the financial instrument if the two amounts are inconsistent. In one non-limiting example, the written amount 214 may supersede any amount identified within the amount field 212.

In some embodiments, successful validation of a financial instrument may depend on correctly extracting from an image of financial instrument 106, via OCR processing, the fields required to complete a remote deposit of financial instrument 106. As a non-limiting example, successful validation of financial instrument 106 may refer to correctly extracting at least MICR line 220, check number 206, payee field 210, and payment amount 212. Successfully validation of financial instrument 106 need not include correctly extracting all identifiable fields from the image (such as all fields identified in FIG. 2). Various financial instrument processing platforms may be used in a remote deposit system, and these processing platforms may be implemented by a bank using third party software. Accordingly, various OCR processing systems and validations may be implemented depending on the remote deposit system, and their inner workings may not be readily known to the bank. As used herein, successful validation may refer to cases in which an image submitted to a financial instrument image processing system, either implemented by a bank or a third party, is not returned due to the financial instrument being an impermissible type.

OCR is the electronic or mechanical conversion of images of typed, handwritten or printed text into machine-encoded text, whether from a scanned document, a photo of a document, a scene photo, stream of image data, etc. Utilizing OCR, data (e.g., financial instrument amount, signature, MICR line, account number, etc.) may be extracted from one or more images of a financial instrument and used to process a remote deposit.

In some embodiments, OCR processing of an image of a financial instrument may include OCR processing performed at a backend system, for example, during a financial instrument image validation process. In such embodiments, the OCR processing may be implemented by a bank associated with a mobile banking app or may be implemented using third-party software hosted on a cloud banking system. OCR processing may include, but is not limited to, verification of data extracted from fields of the financial instrument based on a comparison with historical customer account data found in the customer’s account (e.g., customer account 408) or the payer’s account. In one non-limiting example, an address may be checked against the current address found in a data file of a customer account. In another non-limiting example, OCR processing may include checking a signature file within a customer account to verify the payee or payer signatures. It is also contemplated that a third party database may be checked for funds and signatures for financial instruments from payers not associated with the customer’s bank. Additional known OCR processing techniques may be substituted without departing from the scope of the technology described herein. Further, in some embodiments, OCR processing may be performed at mobile computing device 102. In some embodiments, the real-time image assessment described herein may be performed prior to any OCR processing, regardless of where it occurs, to avoid OCR processing costs if the image is associated with an impermissible financial instrument type.

FIG. 3 illustrates a remote deposit system architecture 300, according to some embodiments. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) may implement remote deposit processing for one or more financial instruments, such as checks or money orders. The client device 302 may be configured to communicate with a cloud banking system 316 to complete various phases of a remote deposit as will be discussed in greater detail hereafter.

In some embodiments, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 may communicate with other devices, such as a client device 302. Components of cloud banking system 316, such as Application Programming Interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

Mobile banking app 304 may be a computer program or software application designed to run on a mobile device such as a phone, tablet, or watch. However, in a desktop application, a desktop equivalent of the mobile banking app may be configured to run on desktop computers, and web applications, which run in mobile web browsers rather than directly on a mobile device, may be implemented for mobile banking app 304. Applications or apps may be broadly classified into three types: native apps, hybrid, and web apps. Native applications may be designed specifically for a mobile operating system, such as iOS or Android. Web apps may be designed to be accessed through a web browser. Hybrid apps may be built using web technologies such as JavaScript, CSS, and HTML5 and function like web apps disguised in a native container.

Mobile banking application (app) 304, resident on client device 302, may include a computer instruction set to provide a secure mobile device banking session. The banking app may allow a customer to interact with their bank account information. For example, common functions include, but are not limited to, checking an account balance, transferring money between accounts, paying bills, making deposits, to name a few.

In some embodiments, mobile banking app 304 may include executable software that may communicate with various systems within client device 302 to provide ML functionality. For example, ML frameworks, for example, those provided by Core ML (iOS) or ML Kit (Android or iOS), may be implemented to establish communications between mobile banking app 304 and client device 302’s ML capabilities. Mobile banking app 304 may include software instructions that interact with application programing interfaces (APIs), programs, libraries, and/or modules of an ML framework. When executed, instructions on mobile banking app 304 may cause ML models implemented by the ML framework and operating on client device 302 to receive and assess image data. As an example, mobile banking app 304 may execute an API call to a Core ML or ML Kit framework to run an image classification ML model and obtain an image classification and/or a confidence score associated with the classification (e.g., using the Vision framework supported by ML Core or the MLKitVision framework provided by ML Kit). The image classification ML model may receive image pixel data gathered via a camera of client device 302, along with image metadata in some embodiments. The image classification ML model may determine, based on the image pixel data and/or image metadata, whether enhancing an image of a financial instrument is readable or unreadable and may provide its determination to mobile banking app 304. In some embodiments, a classification may be provided along with a confidence score indicating a likelihood the classification is correct. In some embodiments, a classification of whether or not an image is readable or unreadable, with or without a confidence score, may be provided by the image classification ML model. While image classification ML models are discussed, any predictive ML model or autoencoder ML model may be implemented using Core ML and ML Kit frameworks.

While Core ML and ML Kit are discussed above as example ML frameworks/ software development kits (SDKs), it should be understood that any suitable ML framework or SDK may be implemented. Various functions of the ML framework(s) implemented may be integrated with mobile banking app 304 or may operate on client device 302 but be separate from mobile banking app 304.

Financial instrument imagery may originate from any of, but not limited to, image streams (e.g., series of pixels or frames) or video streams or a combination of any of these or future image formats. A customer using a client device 302, operating a mobile banking app 304 through an interactive UI 306, may frame at least a portion of a financial instrument (e.g., identifiable fields on the front or back of the financial instrument) with a camera (e.g., field of view). In some embodiments, imagery may processed from live stream financial instrument imagery, as communicated from camera 308 over a period of time, until an image assessment has been completed.

In some embodiments, image data may be assembled into one or more frames of image content. In some embodiments, a data signal from a camera sensor (e.g., a charge-coupled device (CCD) or an active-pixel sensor (such as a complementary metal-oxide-semiconductor (CMOS) image sensor)) may notify mobile banking app 304 and/or mobile ML platform 310 when an entire sensor has been read out as streamed data. In this approach, the camera sensor may be cleared of electrons before a subsequent exposure to light and a next frame of an image is captured. This clearing function may be conveyed to mobile banking app 304 and/or mobile ML platform 310 to indicate that a Byte Array Output Stream object constitutes a complete frame of image data. In some embodiments, images formed into a byte array may be first rectified to correct for distortions based on an angle of incidence, may be rotated to align the imagery, may be filtered to remove obstructions or reflections, and/or may be resized to correct for size distortions using known image processing techniques. In some embodiments, these corrections may be based on recognition of corners or borders of the financial instrument as a basis for image orientation and size, as is known in the art.

In some embodiments, the camera imagery may be streamed as encoded text, such as a byte array. Alternatively, or in addition, one or more frames of the live imagery may be stored (e.g., at least temporarily) as images in computer memory. For example, one or more frames of live streamed financial instrument imagery from camera 308 may be stored locally in image memory 312, which may be, but is not limited to, a frame buffer, a video buffer, a streaming buffer, a virtual buffer, a hard drive, etc.

In some embodiments, image data may be stored in any known file format, for example, as a JPEG, PNG, TIFF, HEIC, or RAW file, or any other file type that supports metadata storage, before being provided to mobile ML platform 310. In some embodiments, metadata may be stored in a variety of formats within an image file, including one or more of EXIF, XMP, XML, 8BIM, IPTC, or ICC formats.

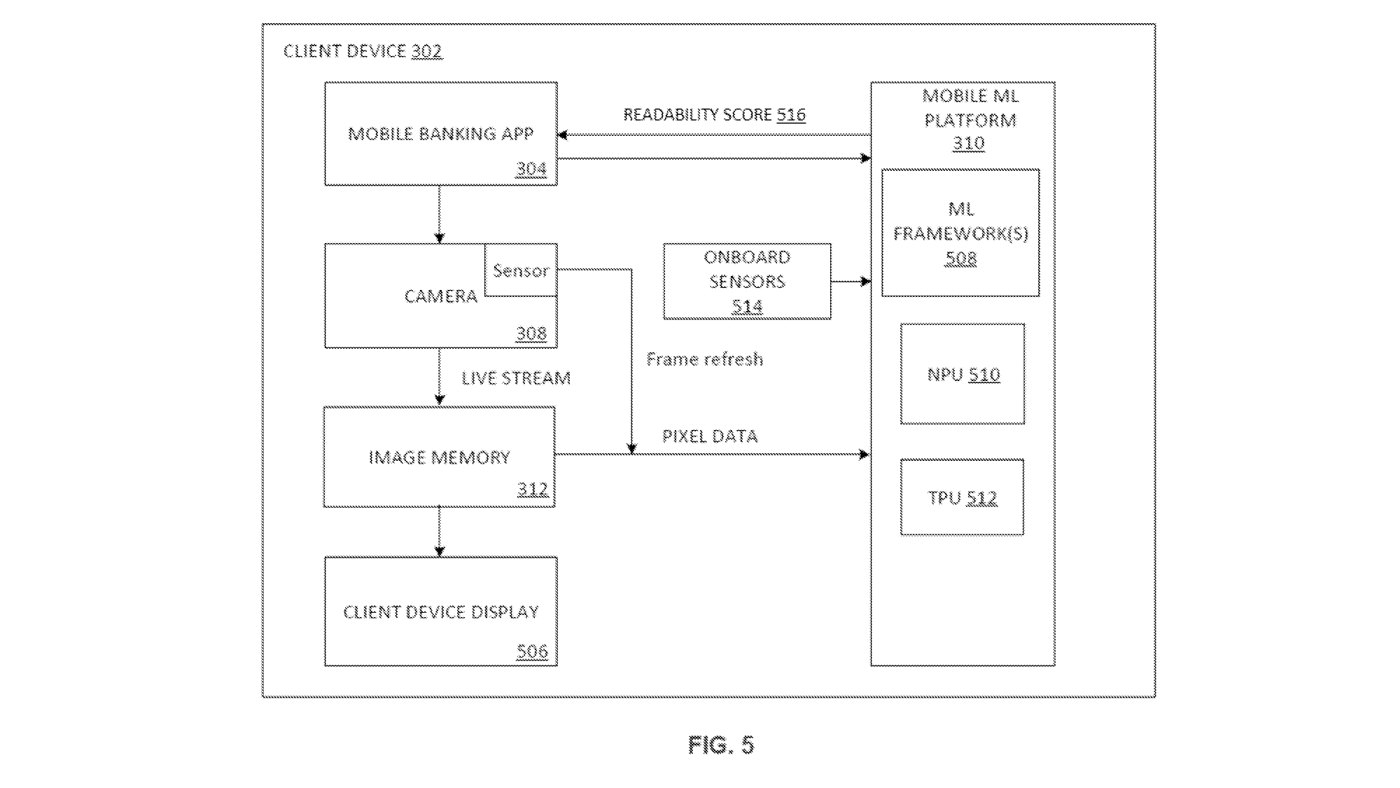

Mobile ML platform 310, which in some embodiments may be resident on the client device 302, may process one or more images (e.g., image frames extracted from a live image stream) received from camera 308 and/or image memory 312 to determine whether an image of a financial instrument is readable or unreadable In some embodiments, the image assessment process may be completed before finalization of a remote deposit operation. Accordingly, in such embodiments, a readability score may be communicated to or determined by mobile banking app 304 for display on UI 306 before the one or more images are forwarded for further processing. In some embodiments, mobile ML platform 310 may include one or more ML frameworks which may implement predictive ML models (e.g., image classification ML models or regression ML models, etc.), as discussed in more detail with respect to FIG. 5.

Account identification 314 may use single or multiple level login data from mobile banking app 304 to initiate a remote deposit. Alternately, or in addition, in some embodiments, the extracted payee field 210 or the payee signature 222 may be used to provide additional authentication of the customer.

Mobile ML platform 310 (e.g., ML framework(s) operating on mobile ML platform 310) may communicate with a cloud banking system 316. For example, mobile ML platform 310 may communicate with cloud banking system 316 to receive trained ML models and/or provide data to cloud banking system 316 that may be used in continuous training of ML models deployed on client device 302 (e.g., a history of predictions, confidence scores, images, and/or image metadata). In some embodiments, such data may be communicated to file database (DB) 320 either through a mobile app server 332 or mobile web server 334 depending on the configuration of the client device (e.g., mobile or desktop). In some embodiments, such data may be communicated through the mobile banking app 304.

Alternatively, or in addition, in some embodiments, a thin client (not shown) resident on the client device 302 may implement ML models or ML model training as disclosed herein to provide local image assessment with assistance from cloud banking system 316. For example, a processor (e.g., CPU) may implement at least a portion of image assessment using resources stored on a remote server instead of a localized memory. The thin client may connect remotely to the server-based computing environment (e.g., cloud banking system 316) where applications, sensitive data, and memory may be stored.

Backend 322 may include one or more system servers processing banking deposit operations in a secure environment. These one or more system servers may operate to support client device 302. API 318 may be an intermediary software interface between mobile banking app 304, installed on client device 302, and one or more server systems, such as, but not limited to the backend 322, as well as third party servers (not shown). The API 318 may be available to be called by mobile clients through a server, such as a mobile edge server (not shown), within cloud banking system 316. File DB 320 may store files received from the client device 302 or generated as a result of processing a remote deposit.

Profile module 324 may retrieve customer profiles associated with the customer from a registry based on customer data extracted from front or back images of the financial instrument (e.g., via OCR processing). Customer profiles may be used to determine deposit limits, historical activity, security data, or other customer related data.

Validation module 326 may generate a set of validations including, but not limited to, any of: mobile deposit eligibility, account, image, transaction limits, duplicate financial instruments, amount mismatch, MICR, multiple deposit, etc. While shown as a single module, the various validations may be performed by, or in conjunction with, the client device 302, cloud banking system 316, or third party systems or data. In some embodiments, OCR processing and/or other image processing of an image of a financial instrument may be performed by validation module 326, which may return a result of image processing (pass/fail). In some embodiments, determination of whether enhancing an image of a financial instrument may result in a successful subsequent OCR may be performed in concert with other image processing (e.g., OCR) and/or by a person at validation module 326. In some embodiments, the determination(s) may be communicated to file DB 320 for storing with the image. In some embodiments, such as when training of an ML model is performed at client device 302, the determination(s) may be communicated to mobile banking app 304 via mobile app server 332. The determination(s) may be used to refine ML image assessment models as disclosed herein.

Customer Accounts 328 (consistent with customer’s accounts 408) may include, but is not limited to, a customer’s financial banking information, such as individual, joint, or commercial account information, balances, loans, credit cards, account historical data, etc.

ML platform 329 may include a predictive ML model and/or a ML engine to train a predictive ML model used to assess images to determine whether enhancing an image of a financial instrument may result in a successful subsequent OCR. ML platform 329 may also include and/or train an autoencoder ML model for enhancing images of financial instruments for subsequent OCR processing. For example, while the above disclosure has focused on a predictive ML model operating on client device 302, in some embodiments, the predictive ML model and/or autoencoder ML model may operate on ML platform 329. In such embodiments, mobile banking app 304 may communicate an image, via mobile app server 332 and/or API 318, to the predictive ML model running on ML platform 329. The predictive ML model running on ML platform 329 may return an image classification result and/or associated confidence score to mobile banking app 304 in real time (e.g., within a current customer transaction period before the payee customer submits a deposit request or immediately after in response to the payee customer submitting the deposit request). In some embodiments, the trained autoencoder ML model running on ML platform 329 may perform a model inference to enhance the image and increase the resolution for subsequent OCR processing.

In some embodiments, ML platform 329 may be used to train a predictive ML model and/or autoencoder ML model that may then be made available to mobile banking app 304 via mobile ML platform 310. In such embodiments, ML platform 329 may include or implement ML platforms such as Create ML (Mac), TensorFlow (Windows), or any suitable platform for training ML models.

This disclosure is not intended to limit ML platform 329 to only image assessment as it may also include or be used to train and/or implement remote deposit models, risk models, funding models, security models, dynamic funds availability models, etc.

In some embodiments, ML platform 329 may include software produced and implemented by the bank providing mobile banking app 304, and not third-party software. Alternatively, or in addition, ML platform 329 may include software produced and implemented by a third party.

In some embodiments, a funds availability schedule may be generated using an ML platform 329, as described in U.S. Application No. 18/509,748, filed November 15, 2023 and titled “DEPOSIT AVAILABILITY SCHEDULE,” the disclosure of which is incorporated by reference herein in its entirety. When a funds availability schedule is generated, it may be passed back to the client device 302 through API 318 where it may be formatted for communication and display on the client device 302. For example, the funds availability schedule may be communicated for display or rendering on the customer’s device through the mobile banking app UI 306. In some embodiments, UI 306 may instantiate the funds availability schedule as images, graphics, audio, additional content, etc.

Pending deposit 330 may include a profile of a potential upcoming deposit(s) based on an acceptance by the customer through UI 306 of a deposit according to given terms. If the deposit is successful, the system may create a record for the transaction and this function may retrieve a product type associated with the account, retrieve data on customer interactions with UI 306, and create a pending financial instrument deposit activity.

One or more components of the remote deposit process described above may be implemented within the client device 302, third party platforms, the cloud-based banking system 316, or distributed across multiple computer-based systems.

Additionally, while the embodiments of FIG. 3 are discussed in the context of remote deposit, components and/or features of remote deposit system architecture 300 may be implemented in any electronic document verification system. For example, in some embodiments, backend 322 may include server(s) implementing identification document verification based on image(s) of identification documents provided via client device 302. In some embodiments, client device 302 may implement a mobile ML platform 310 that is used to determine identification document type data in real-time as disclosed herein for a financial instrument. Likewise, alternatively or additionally, ML platform 329 may be used to determine identification document type data as disclosed herein for a financial instrument. The disclosure related to one or more components and/or features of remote deposit system architecture 300 may be applied in system architectures for any digital document verification process.

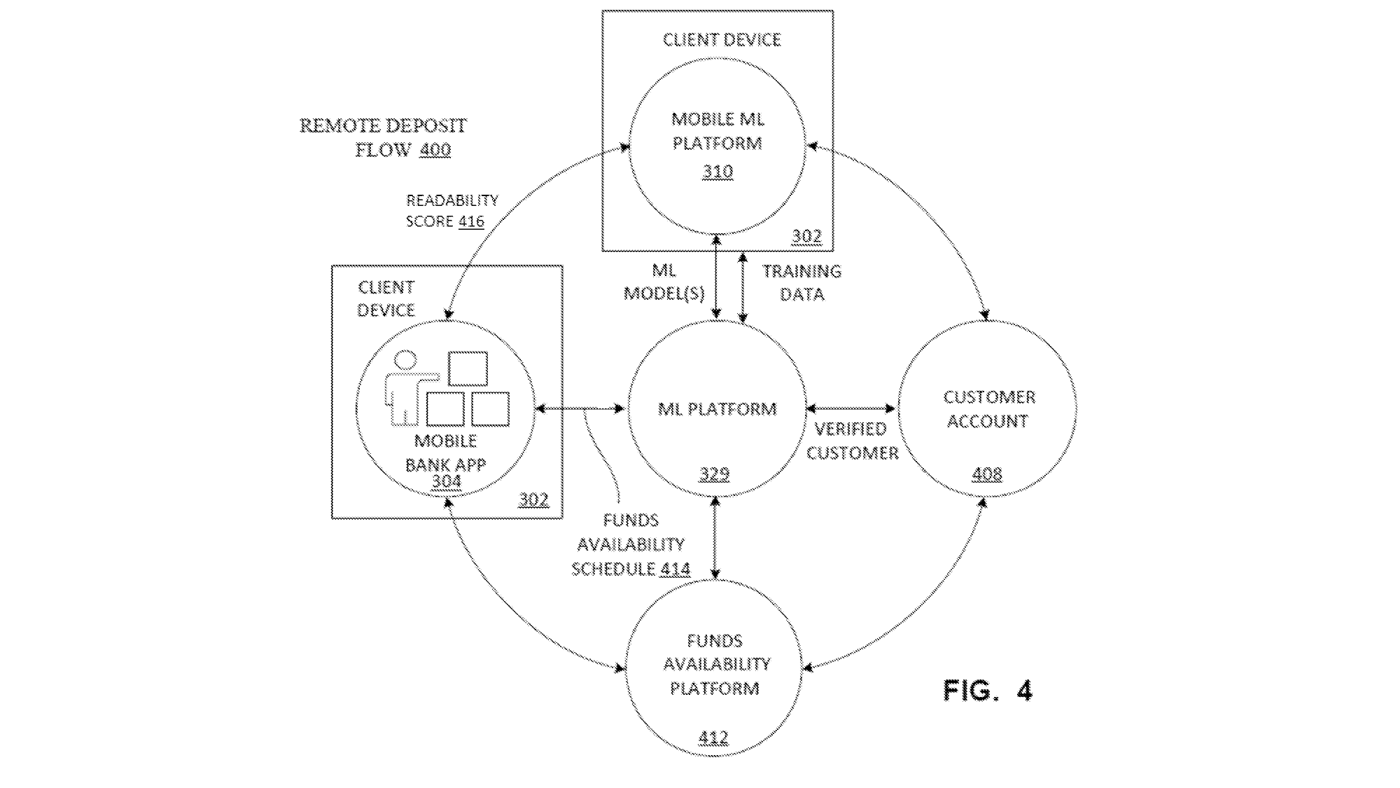

FIG. 4 illustrates an example flow diagram of a remote deposit system, according to some embodiments. The remote deposit flow 400 may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that can comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In one non-limiting example, a bank customer using a client device 302 (e.g., mobile computing device 102), operating a mobile banking app 304, may frame at least a portion of a financial instrument within a field of view from an active camera (e.g., camera activated) of client device 302. As previously described, the imagery within the field of view may, in some embodiments, be configured as a live stream. In some embodiments, the camera imagery may be streamed as encoded text, such as a byte array (e.g., as a Byte Array Output Stream object). In some embodiments, this live stream of image data may be processed, without requiring image storage, using a client device resident mobile ML platform 310 (e.g., including ML framework(s)). In alternative embodiments, one or more frames of the camera imagery may be at least temporarily stored and subsequently processed by mobile ML platform 310. In some embodiments, a blended image as disclosed in U.S. Application No. 18/503,787, filed November 7, 2023 and titled “BURST IMAGE CAPTURE,” the disclosure of which is incorporated by reference herein in its entirety, may be captured and subsequently processed by mobile ML platform 310.

An ML model implemented by mobile ML platform 310 may provide an image assessment in real time, based upon which a readability score 416 may be generated in real time (e.g., within a current customer transaction period before the payee customer submits a deposit request or immediately after in response to the payee customer submitting the deposit request). In some embodiments, readability score 416 may include an image readability score indicating whether or not an image meets a threshold level of readability for enhancement. A readability score 416 above the threshold level of readability may suggest that enhancing an image may result in a successful subsequent OCR. A readability score 416 below the threshold level of readability may suggest that enhancing an image may not result in a successful subsequent OCR. Readability score 416 may communicate similar information for an image of an identification document provided as part of an access request.

Sample readability score 416 may include, but are not limited to, “Readability Score: 85%,” “High chance of successful remote deposit,” “Low image visibility”, etc. These readability scores are provided as sample scores or outputs but any scores or outputs that provide guidance on financial instrument or document readability may be included. UI 306 may instantiate readability score 416 as text, images, graphics, audio, additional content, etc.

In some embodiments, readability score 416 may be generated based on results of an image classification ML model running on either mobile ML platform 310 or ML platform 329. In the second case, in some embodiments, readability score 416 may be generated at cloud banking system 316 (e.g., at API 318 or ML platform 329) and transmitted to mobile banking app 304 for display. In the first or second case, in some embodiments, readability score 416 may be generated by mobile banking app 304 based on the results of the image classification ML model.

In one technical improvement over current processing systems, readability score 416 may be provided mid-stream, prior to a customer submitting a deposit request or immediately after in response to the customer submitting the deposit request. In this approach, the customer may terminate the process prior to completion if they are dissatisfied with the readability score 416, or may retake an image.

ML platform 329 and mobile ML platform 310 may be in communication for the training and refinement of ML models implemented by mobile ML platform 310. For example, ML algorithms may be trained on ML platform 329 using training data, which may include images captured by client device 302. A resulting ML model may be provided to client device 302. Additionally, the ML model may be continuously refined. In some embodiments, the ML model may be refined on ML platform 329 based on training data that may be provided to ML platform 329 by client device 302. The training data may include images and associated data. In some embodiments, the associated data transmitted by client device 302 may include results of real time ML image assessment performed at client device 302 and/or image metadata from the time of image capture. In such embodiments, items of the associated data may be associated with individual images. In some embodiments, an ML model refined at ML platform 329 may be provided to client device 302 and may be accessible in new versions of mobile banking app 304 (i.e., the refined model may be provided as part of a software update).

In some embodiments, an ML model may be refined on client device 302. For example, in the case of a predictive ML model operating on client device 302, refining the model may include determining OCR processing of an image has failed even though the image was classified as “pass” based on the results of the predictive ML model’s analysis. This determination may be performed on cloud banking system 316, for example, by validation module 326. In such cases, the predictive ML model may have provided a prediction that the image would pass OCR processing, or a confidence score that met a threshold for such a prediction, and based on the predictive ML model’s prediction, the image may have been forwarded for further processing. But the image may have been rejected due to an inability to perform OCR processing on the image. Additionally or alternatively, the image may have been classified (e.g., by a person or program operating as part of validation module 326) as a different type than a predicted type, even though validation succeeded. In such cases, refining the predictive ML model may include providing the determination that the image has failed OCR processing to mobile banking app 304 (e.g., via mobile app server 332 and/or API 318). The determination may be provided with the rejected image or with an identifier for locating the rejected image within image memory 312. Accordingly, mobile banking app 304 may receive or create a label associated with the failed image, based on the determination. Mobile banking app 304 may then provide the labeled, rejected image (with or without image metadata) to the predictive ML model for further training on an ML framework of mobile ML platform 310. In some embodiments, cloud banking system 316 and mobile banking app 304 may do the same for an image that has passed OCR processing to facilitate continuous training of the predictive ML model.

In embodiments in which the predictive ML model may be trained and/or refined at client device 302, the predictive ML model may be a file (e.g., an .mlmodel file for Core ML) that is configured to allow updating (e.g., the model may be marked as updatable and/or has training inputs). In the case of a neural network, the file may be made updateable by marking certain layers as updatable, including one or more loss functions (e.g., cross-entropy or mean squared error (MSE)), including an optimizer (stochastic gradient descent (SGD) or Adam), and/or including default values for the hyperparameters (e.g., the number of epochs).

While the above process has been described for refining the predictive ML model on client device 302, in some embodiments, the same or a similar process may be performed on ML platform 329. In some embodiments, the predictive ML model may be trained and/or refined using distributed training, leveraging the interactions of multiple client devices 302 and cloud banking system 316, where each client device 302 constitutes a node in the distributed training network. In such embodiments, the distributed training may implement a data parallelism approach.

Client device 302 may obtain and transmit financial instrument images, including but not limited to front and back images of a financial instrument, captured using camera 308 and image slices obtained via segmentation and/or other image processing techniques (e.g. image slices obtained based on predetermined image boundary coordinates or guided user prompts). The financial instrument images may then be stored in the customer account 408 for later use if necessary. In some embodiments, the financial instrument images may be stored (e.g., in file DB 320) with associated data including image metadata, results of real time ML image assessment, final financial instrument readability determinations, or any combination thereof. The financial instrument images and associated data may be used to refine one or more ML models operating within remote deposit flow 400, as described above.

The customer account 408, for purposes of description, may be the payee’s account, the payer’s account or both. For example, a payee’s account historical information may be used to calculate a payee’s funds availability schedule 414, while a payer’s account may be checked for funds to cover the financial instrument amount.

Data fields extracted in an OCR operation may be communicated to a funds availability platform 412. For example, customer data (e.g., name, address, account number, bank information (e.g., routing information), financial instrument number (e.g., check number), financial instrument amount (e.g., funding amount needed), authorization and anti-fraud information (e.g., signature verifications, watermark or other financial instrument security imagery), etc. may be communicated to funds availability platform 412.

ML platform 329, in communication with funds availability platform 412, may compute a funds availability schedule 414 based on one or more of the received data fields, customer history received from the customer’s account 408, bank funding policies, legal requirements (e.g., state or federally mandated limits and reporting requirements, etc.), or typical schedules stored within funds availability platform 412, to name a few. ML platform 329 may return a fixed or dynamically modifiable funds availability schedule 414 to the UI 306 on the client device 302. ML platform 329 may perform any of the above functions in line with the disclosure of U.S. Application No. 18/509,748, filed November 15, 2023 and titled “DEPOSIT AVAILABILITY SCHEDULE,” which is incorporated by reference herein in its entirety.

In a non-limiting example, OCR of a financial instrument image may identify the MICR data as a verified data field that may be used to access a customer’s account 408. This access may allow the bank identified in the MICR to provide a history of the customer’s account 408 to the ML platform 329, via any channel of remote deposit system architecture 300. Early access to the customer’s account may also provide a verified customer for security purposes to eliminate or reduce fraud in the remote deposit process.

ML platform 329 may provide funds availability schedule 414, which may be communicated and rendered on the client device 302 within one or more user interfaces (UIs) of the customer device’s mobile banking app 304. The rendering may include imagery, text, or a link to additional content. The UI may instantiate the remote funds availability schedule 414 as images, graphics, audio, etc. In some embodiments, an estimated date of deposit may be communicated. In some embodiments, funds availability schedule 414 and readability score 416 may be combined and communicated simultaneously. In some instances, funds availability schedule 414 may include a notice of failed processing (e.g., OCR processing of a deposit financial instrument image has failed).

Alternatively, or in addition, one or more components of the remote deposit flow 400 may be implemented within the customer device, third party platforms, and a cloud-based system or distributed across multiple computer-based systems.

FIG. 5 illustrates an example diagram of a client device 302, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In some embodiments, the mobile banking app 304 may be opened on the client device 302 and the deposit check function selected to initiate a remote deposit process. A camera may be activated (e.g., camera 308) to communicate a live stream of imagery (e.g., frames of video) from a field of view of the camera 308. A camera may output, for display at client display device 506, a frame (e.g., an image frame or a frame of a video, for example) depicting one or more real-world objects that are viewable by camera 308. For instance, an image may depict an entire group of checks in a field of view of camera 308, or the image may depict one or more individual objects within the group. In some embodiments, the image of decodable check indicia may be provided by a raw image byte stream or by a byte array, a compressed image byte stream or byte array, and/or a partial compressed image byte stream or byte array.

At this point, the customer of the client device 302 may view the live stream of imagery on a UI of the client device display 506, after buffering in image memory 312, which may include a buffer (e.g., frame buffer, video buffer, etc.). In some embodiments, the live stream may communicated to mobile ML platform 310 as a raw image live stream. In some embodiments, the raw image live stream may first be converted to a byte array and then communicated to mobile ML platform 310 (buffered or not buffered, or after being stored in permanent memory). The data embedded in the byte stream or byte array may then be extracted by a predictive ML model implemented by ML framework(s) 508 of mobile ML platform 310, processed, and used to issue a prediction (e.g., a classification result and/or confidence score such as readability score 516). This prediction may be transmitted to mobile banking app 304 periodically (e.g., after an image has been provided to the predictive ML model) or continuously (e.g., as frames in a continuous image stream are being assessed). In embodiments in which a live stream is provided to the predictive ML model, the prediction output by the predictive ML model may be used to trigger automatic image capture (e.g., selecting and storing and/or transmitting an image frame for further processing).

In some embodiments, the front side imagery may be processed followed by the back side imagery. Alternatively, or in combination, the front side and back side imagery may be processed together or in parallel.

As shown in FIG. 5, mobile ML platform 310 may include ML framework(s) 508, neural processing unit (NPU) 510, and/or tensor processing unit (TPU) 512. In some embodiments, mobile ML platform 310 may include both neural processing unit 510 and tensor processing unit 512. In alternative embodiments, mobile ML platform 310 may include either neural processing unit 510 or tensor processing unit 512.

Traditionally, machine learning models may be implemented on a mobile device using the processing capabilities of the mobile device’s CPU and/or GPU. However, a NPU 510 or TPU 512 may be optimized for matrix operations, such as matrix multiplication and convolutions, which constitute some of the most common and computationally intensive mathematical operations performed in machine learning. Accordingly, NPUs and TPUs may be optimized for machine learning tasks, and in particular implementing artificial neural networks and deep learning.

ML framework(s) 508 may include programing interfaces (APIs), programs, libraries, and/or modules that operate on client device 302’s CPU, GPU, NPU 510, and/or TPU 512. In some embodiments, ML framework(s) 508 may implement ML models that have been trained on ML platform 329 and downloaded onto client device 302 as part of mobile banking app 304’s installation package. In alternative embodiments, ML framework(s) 508 may implement ML models that have been trained using ML framework(s) 508 on client device 302. In some embodiments, ML framework(s) 508 may be configured to implement computer vision ML models, such as computer vision-based predictive ML models (e.g., image classification ML models, computer vision-based regression models, autoencoder models etc.). As a non-limiting example, an ML framework 508 may be Apple’s Vision framework, supported by Core ML.

In some embodiments, an image classification ML model operating on ML framework(s) 508 may be configured, via training at cloud banking system 316 and/or client device 302, to categorize an image provided to an image classification model as either readable (predicted to pass subsequent OCR processing after image enhancement) or unreadable (predicted to fail subsequent OCR processing after image enhancement). In some embodiments, the image classification ML model may further be configured to provide a readability confidence score associated with one or more of the readable/unreadable predictions. For example, in some embodiments, the image classification ML model may be configured to provide both a readability confidence score (e.g., a percentage) predicting whether the image will pass subsequent OCR processing after image enhancement and an unreadability confidence score (e.g., a percentage) predicting whether the image will fail subsequent OCR processing after image enhancement. For example, in such embodiments, the image classification ML may indicate that an image is 75.5% likely to pass subsequent OCR processing after enhancement, and 30% likely to fail subsequent OCR processing after image enhancement. In some embodiments, the image classification ML model may be configured to provide only a readability confidence score predicting whether the image is readable. In some embodiments, the image classification ML model may be configured to provide only a readability confidence score predicting whether the image is unreadable. In some embodiments, the image classification ML model may be configured to not provide a confidence score, but only a binary determination (e.g., readable/unreadable).

Alternatively, or in addition, in some embodiments, an image classification ML model operating on ML framework(s) 508 may be configured, via training at cloud banking system 316 and/or client device 302, to categorize an image provided to an image classification model as either pass (predicted to pass OCR processing) or fail (predicted to fail OCR processing). In some embodiments, the image classification ML model may further be configured to provide a confidence score associated with one or more of the pass/fail predictions. For example, in some embodiments, the image classification ML model may be configured to provide both a confidence score (e.g., a percentage) predicting whether the image will pass and a confidence score (e.g., a percentage) predicting whether the image will fail. For example, in such embodiments, the image classification ML may indicate that an image is 72.5% likely to pass, and 27.5% likely to fail. In some embodiments, the image classification ML model may be configured to provide only a confidence score predicting whether the image will pass. In some embodiments, the image classification ML model may be configured to provide only a confidence score predicting whether the image will fail. In some embodiments, the image classification ML model may be configured to not provide a confidence score, but only a binary determination (e.g., pass/fail).

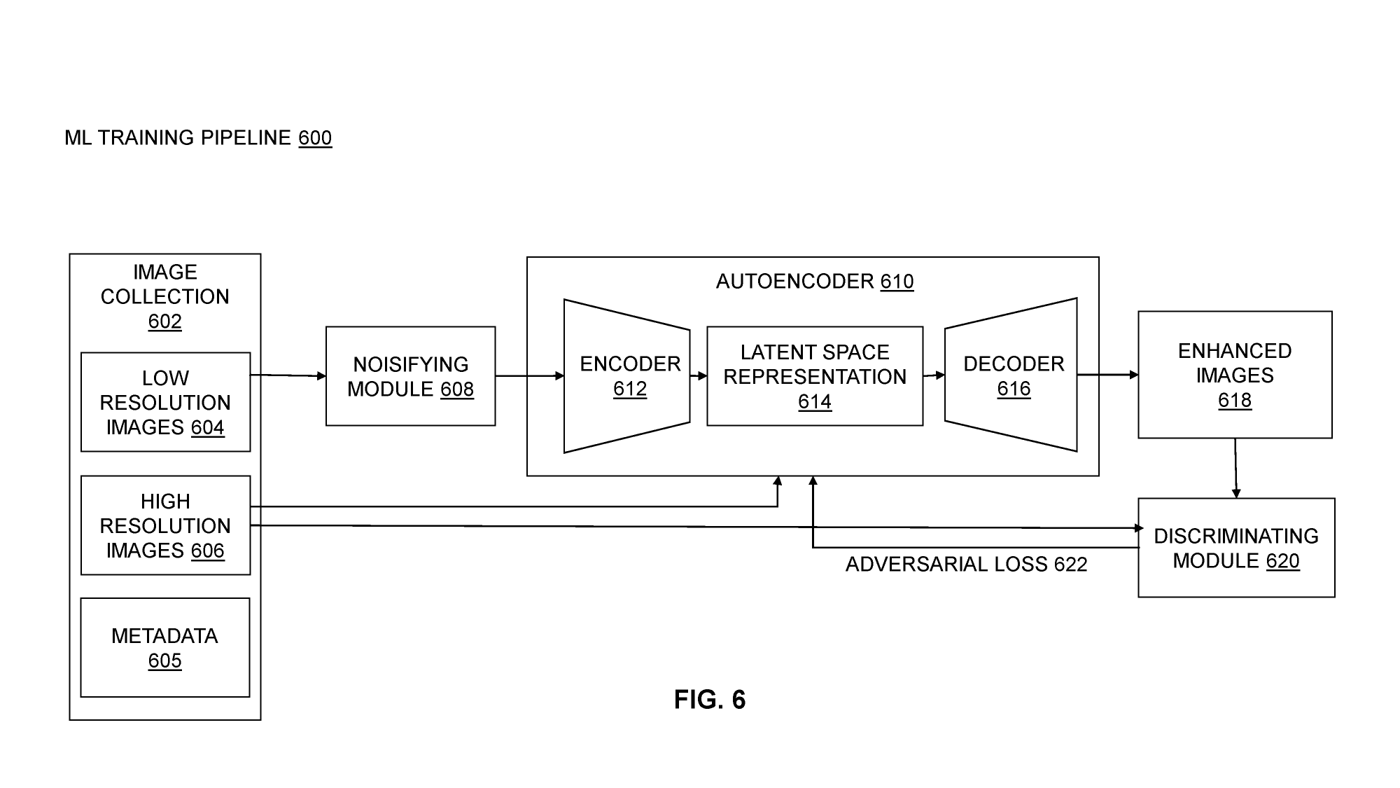

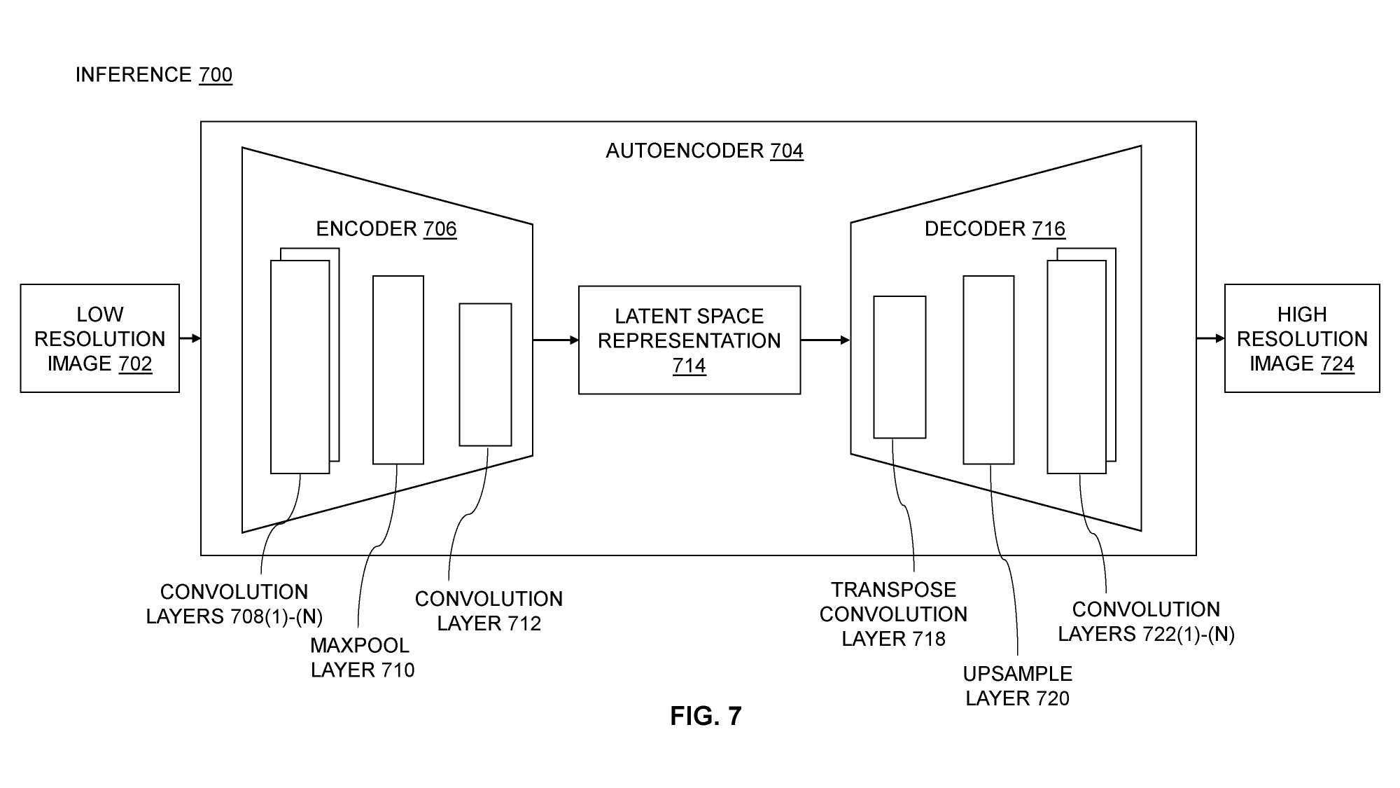

In some embodiments, an autoencoder ML model operating on ML framework(s) 508 may be configured, via training at cloud banking system 316 and/or client device 302, to enhance an image for subsequent OCR processing. In some embodiments, the autoencoder ML model may increase the resolution of a low resolution or blurry image that is failing or predicted to fail an OCR process. In some embodiments, the autoencoder ML model may denoise a noisy image to produce a clean image. An example training and inference process of such an autoencoder ML model will be described further in FIGS. 6 and 7 respectively.

In some embodiments, after providing a financial instrument image to a predictive ML model (e.g., an image classification ML model), mobile banking app 304 (or another component within remote deposit system architecture 300) may receive a determination from the predictive ML model regarding a financial instrument readability. For example, mobile banking app 304 (or the other component) may receive from the predictive ML model a confidence score indicating a likelihood that a subsequent OCR will be successful upon enhancing the financial instrument image (a financial instrument readability confidence score. In some embodiments, one or more predetermined thresholds may be set within mobile banking app 304.

In response to the financial instrument readability confidence score meeting a predetermined threshold related to financial instrument readability, mobile banking app 304 may then may forward the financial instrument image for image enhancement and further processing (e.g., at cloud banking system 316 or a third party server). In response to the financial instrument readability confidence score not meeting the predetermined threshold related to financial instrument readability, mobile banking app 304 may reject the financial instrument image. In some embodiments, in response to the financial instrument readability confidence score not meeting (e.g., being below) the predetermined threshold related to financial instrument type readability, mobile banking app 304 may request re-capture of the image and/or may trigger auto-recapture to verify that other factors (e.g., blurriness) are not preventing a classification from being made. In some embodiments, once it is confirmed that no financial instrument readability confidence score associated with a financial instrument being captured meets the predetermined threshold related to financial instrument type readability, mobile banking app 304 may indicate that the financial instrument itself is unreadable.

In some embodiments, the predetermined threshold may be set within the predictive ML model, rather than within mobile banking app 304. In such embodiments, the predictive ML model may provide a classification result (e.g., readable/unreadable determination or pass/fail determination) based on the confidence score meeting the predetermined threshold. In some embodiments, mobile banking app 304 may forward the check image for image enhancement in response to the classification results indication “fail” and “readable” (i.e. when an OCR process has failed or has been predicted to fail, but the image meets a threshold level of readability from which a subsequent OCR may be successful upon image enhancement). In some embodiments, mobile banking app 304 may forward the financial instrument image for image enhancement in response to the classification result indicating “readable” without first obtaining a classification result from the pass/fail image classification model (i.e. performing image enhancement on an image that meets the threshold level of readability regardless of an initial OCR pass/fail prediction). This may result in more model generalizability, as the readable/unreadable image classification model can be trained on a broader range of financial instrument images, namely the set of images that that includes both the pass images and the fail images (versus simply the fail images). Increased model generalizability may lead to a more robust and accurate model.

While mobile banking app 304 is described above as receiving confidence scores and performing actions, other components within remote deposit system architecture (e.g., programs or APIs operating on cloud banking system 316) may perform the operations described above, particularly if the predictive ML model is implemented off of client device 302.

Whether the one or more predetermined thresholds are set within mobile banking app 304 (or another component of remote deposit system architecture 300) or the predictive ML model (or one in each), the one or more predetermined thresholds may be set manually (i.e., by direct coding) in response to one or more factors or automatically in response to the one or more factors. The factors may include a number of images used so far to train the predictive ML model (more images may lead to more accurate predictions) and/or a successful prediction rate (i.e., based on a percentage of images that have been incorrectly classified). In embodiments in which the predetermined threshold is set automatically, mobile banking app 304 or the trained predictive ML model may include a program that receives one or more of the above factors and returns the predetermined threshold.

In some embodiments, when the financial instrument readability confidence score is used, the predetermined threshold related to financial instrument type certainty may be from 50% to 100%, including subranges. For example, in some embodiments, the predetermined threshold related to financial instrument type certainty may be from 55% to 100%, from 60% to 100%, from 65% to 100%, from 70% to 100%, from 75% to 100%, from 80% to 100%, from 85% to 100%, from 90% to 100%, or from 95% to 100%.

While confidence scores that are percentages are discussed herein, other types of confidence scores are contemplated, such that a confidence score is not limited to a percentage. Confidence scores may be numbers on a scale, e.g., 0 to 1, 0 to 10, etc.

As shown in FIG. 5, client device 302 may include onboard sensors 514. In some embodiments, onboard sensors 514 may include a gyroscope, an accelerometer, a magnetometer, time-of-flight (ToF) sensor, structured light illumination (SLI) sensor, light detection and ranging (LiDAR) sensor, or any combination thereof. In some embodiments, onboard sensors 514 may provide data that may be used, along with pixel data from camera 308, to perform a real time image readability assessment. In some embodiments, onboard sensors 514 may include an inertial measurement unit (IMU), which may include three accelerometers, three gyroscopes, and three magnetometers.

In some embodiments, a predictive ML model implemented by ML framework(s) 508 may receive data determined using one or more onboard sensors 514 and may use the data in determining the likelihood a financial document image associated with the data will be successfully processed via a subsequent OCR after image enhancement to obtain deposit data. For example, in some embodiments, an accelerometer of onboard sensor 514 may determine an acceleration value at the time the financial document image is captured. The acceleration value may be stored with the financial document image as metadata associated with the financial document image. In some embodiments, predictive ML model may determine the likelihood the financial document image will be successfully processed via a subsequent OCR after image enhancement based on the financial document image and the acceleration data. In some embodiments, the same process may be implemented with gyroscope data (e.g., angular velocity), with or without acceleration data determined using an accelerometer. In embodiments in which onboard sensor data is used, the predictive ML model may be trained using such onboard sensor data, by providing the onboard sensor data as image metadata of training images.

The technical solution disclosed above allows a real time financial instrument image enhancement, without requiring any subsequent upload and/or OCR processing of the initial image, and communication thereof. This solution accelerates the remote financial instrument deposit process.

FIG. 6 illustrates a machine learning (ML) training pipeline 600, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 6, as will be understood by a person of ordinary skill in the art.

ML training pipeline 600 illustrates the process of training autoencoder 610 for enhancing a low resolution image. In some embodiments, ML training pipeline 600 may operate partially or entirely within remote deposit system architecture 300. Alternatively or additionally, in some embodiments, ML training pipeline 600 may operate partially or entirely at third party servers, within the cloud, or at a financial institution. In some embodiments, noisifying module 608 and/or discriminating module 620 may be accessible though API calls within remote deposit system architecture 300. In such embodiments, noisifying module 608 and/or discriminating module 620 may include third party software implemented within cloud banking system 316 or at a third party server.

As shown in FIG. 6, ML training pipeline 600 may include an image collection 602. In some embodiments, image collection 602 may include images captured using a client device 302 and submitted by one or more customers of mobile banking app 304 (or one or more customers of a software interface that enables image capture and submission from a mobile device). In some embodiments, image collection 602 may include images gathered from third party sources (e.g., internet archives), with or without images submitted by one or more customers of mobile banking app 304. Image collection 602 may include images depicting a financial instrument (e.g., financial instrument 106) or other document, such as low resolution (LR) images 604 and high resolution (HR) images 606. However, the disclosure is not limited to financial instruments but rather can include identification documents, e.g., driver’s license, passport, etc. or any type of document that can be captured and benefit from enhancement. Additionally, the terms low resolution (LR) and high resolution (HR) are used herein for convenience. In some embodiments, low resolution (LR) may refer to images that do not meet a threshold level of resolution. High resolution (HR) may refer to images that meet a threshold level of resolution.

In some embodiments, LR images 604 and HR images 606 may contain image pairs corresponding to the same financial instrument (e.g. a low resolution and high resolution image of financial instrument 106). In some embodiments, LR images 604 may contain images that were artificially generated from HR images 606. In some embodiments, HR images 606 may be downsampled to produce corresponding LR images 604. In some embodiments, a filter may also be applied to HR images 606 to produce corresponding LR images 604. In some embodiments, LR images 604 and HR images 606 may depict a front side of a financial instrument or other document. In some embodiments, LR images 604 and HR images 606 may depict both a front and a back side of a financial instrument or other document (e.g., be a merged picture). In some embodiments, LR images 604 and HR images 606 may depict a back side of a financial instrument or other document. In some embodiments, LR images 604 and HR images 606 may include image slices obtained via segmentation and/or other image processing techniques (e.g. image slices obtained based on predetermined image boundary coordinates or guided user prompts). In yet another embodiment, LR images 604 and HR images 606 may be portion or multiple portions of a financial document, e.g., a portion of the financial document that includes the signature, a portion of a financial document that includes the MICR, a portion of a financial document that includes the amount, a portion of a financial document that includes the date, etc., and any combinations or subcombinations thereof. In some embodiments, LR images 604 and HR images 606 may include pixel data. In some embodiments, the pixel data may be RGB data, CMYK data, YCbCr data, HSV data, HSL data, hex codes, or any other pixel data that may be processed and analyzed by an ML model.

In some embodiments, image collection 602 may also include metadata 605. One or more items of metadata 605 may be associated with each of LR images 604 or HR images 606. In some embodiments, metadata 605 may be linked to an image from LR images 604 or HR images 606. For example, in some embodiments, items of metadata 605 may be stored with pixel data of the image from LR images 604 or HR images 606 in a single image file, for example, a JPEG, PNG, TIFF, HEIC, or RAW file, or any other file type that supports metadata storage. In some embodiments, metadata 605 may be stored in a variety of formats within the image file, including one or more of EXIF, XMP, XML, 8BIM, IPTC, or ICC formats.

In some embodiments, metadata 605 may include a timestamp (e.g., date/time, and optionally sub-second time) that may be used to identify LR images 604 or HR images 606. Additionally or alternatively, in some embodiments, metadata 605 may include values for parameters that may be associated with color and/or image capture conditions. For example, in some embodiments, metadata 605 may include values for shutter speed, focal length, aperture, f-number, ISO number, contrast, distance from the camera to the financial instrument in LR images 604 or HR images 606 (e.g., determined using LiDAR at the time of image capture), or any combination thereof. These values may provide context for an image that will help autoencoder 610 normalize pixel data while being trained. For example, the combination of shutter speed, f-number, and ISO number, which affect exposure, may affect brightness (i.e., color intensity). Accordingly, when these values are included in training data with pixel data, the resulting model may learn to treat high brightness coupled with high exposure the same or similarly to how it treats low brightness coupled with low exposure. This may improve the quality of the images generated by the model (e.g., the model will focus more on capturing “real” similarities or differences between financial instruments depicted in images, and not those caused by camera settings or position of the camera with respect to a captured financial instrument).

Any one or combination of the above values may be associated with a particular image from LR images 604 or HR images 606. As a non-limiting example combination, metadata 605 may include values for shutter speed, f-number, and ISO number, along with values for none or a subset of the other parameters indicated above (e.g., contrast). This combination may be useful since shutter speed, f-number, and ISO number may give information on exposure, which influences brightness.

In some embodiments, any one or combination of the above values may be added to image metadata (e.g., EXIF metadata) by mobile banking app 304 prior to mobile banking app 304 transferring an image 604 to complete a deposit. In some cases, when mobile banking app 304 adds a metadata value to image metadata, it may query software implementing client device 302’s camera 308 to ascertain the metadata value. Alternatively, or in addition, any one or combination of the above values may be automatically added to image metadata (e.g., EXIF metadata) at the time of capturing an image by existing programs within client device 302.

In some embodiments, the distance from the camera to the financial instrument in an image may be determined by leveraging augmented reality (AR) capabilities of client device 302. For example, mobile banking app 304 may interact with an AR platform on client device, within which an AR framework such as ARKit (IOS) or ARCore (Android) may operate. The AR platform may include software and internal sensors (e.g., gyroscopes, accelerometers, magnetometers, and/or LiDAR sensors, ToF sensors, etc.) that can determine a real world position and orientation of various objects within the field of view of camera 502 both relative to a real world coordinate system and relative to camera 502, as described in more detail in U.S. Patent Application No. 18/529,623, filed December 5, 2023 and titled “AUGMENTED REALITY DATA CAPTURE AID,” the disclosure of which is incorporated by reference in its entirety. Using the AR platform, mobile banking app 304 can obtain data on the real world distance between a plane (e.g., financial instrument 106) detected in the field of view of camera 502, for example, by leveraging plane detection and calculating distance to the center or a surface of the plane using the plane’s coordinates. In some embodiments, the distance may be determined from an output of a LiDAR sensor or ToF sensor.

In some embodiments, alternatively or additionally, distance from the camera to a document in LR images 604 or HR images 606 may be determined using multiple lenses and/or cameras on client device 302, data from each of which may be compared to obtain depth data. For example, the difference in location of an object within two images captured using two lenses on the same device may be used to calculate distance to the object from the lenses.

While various types of metadata 605 have been described above, the examples provided are not limiting and it should be understood that any type of metadata 605 may be associated with LR images 604 or HR images 606 for training autoencoder 610. Training autoencoder 610 using both pixel data and metadata 605 may increase the quality of the images generated by autoencoder 610 by providing context for raw pixel data received by the model, enabling processing of images received as training data to be influenced more by real-world captured object features and less by camera settings.

As shown in FIG. 6, ML training pipeline 600 may also include noisifying module 608. Noisifying module 608 may be used to add noise to the training data (e.g. LR images 604) before the training data passes through autoencoder 610. In some embodiments, noisifying module 608 may operate using resources of cloud banking system 316 and/or third party server.

In a non-limiting example, noisifying module 608 may add Gaussian noise or salt and pepper noise to LR images 604. By artificially adding noise to the training data, autoencoder 610 may become more robust to the random noise that exists in real world data. As a result, autoencoder 610 may differentiate better between signal and noise when enhancing an image. In some embodiments, noisifying module 608 may select a uniform noise intensity value to apply to all LR images 604. In some embodiments, noisifying module 608 may select noise intensity values to apply to LR images 604 at random. In some embodiments, noisifying module 608 may only select a subset of LR images 604 to add noise to. In doing so, noisifying module 608 may create diverse training data sets that can properly reflect the diversity and nuance of real world data, allowing autoencoder 610 to generate higher-quality images.

The noisified images produced by noisifying module 608 may be provided to an untrained or partially trained autoencoder 610 to further train autoencoder 610. An “untrained or partially trained” model may refer to a completely untrained model (i.e. a model with default weight values) or a model that has received some training (i.e. a model with partially updated weight values). Any level of training may be considered “partially trained” if a model can be further trained to fine-tune the model, for example, to better perform a specific task. An example of a partially trained ML model may be a pre-trained ML model. In some embodiments, a pre-trained autoencoder 610 may be trained on ML platform 329 using multiple customer’s data, and then further trained on either ML platform 329 or mobile ML platform 310 using a single customer’s data. In some embodiments, a pre-trained autoencoder 610 generated by a third party may be obtained and trained using transfer learning to repurpose the pre-trained autoencoder 610 to the image enhancement process described herein. The transfer learning may be conducted at ML platform 329 and may involve training as disclosed herein.

“Further train,” “further trained,” or “further training” should not be interpreted to mean that a model has already been at least partially trained before being “further trained.” Rather “further train,” “further trained,” or “further training” may refer to an ML model that was partially trained and has now undergone additional training, or may refer to an ML model that was entirely untrained and has undergone some training. Accordingly, “further trained” indicates that a model receives additional training, refinement, updating, etc., than it previously had. Likewise, “train,” “training,” or “trained” should not be interpreted to mean in all cases that a model is fully trained (e.g., using a particular method or at a particular location in remote deposit system architecture 300) and cannot be refined or updated further, but only that some amount of training is being or has been performed (e.g., using a particular method or at a particular location).

In some embodiments, autoencoder 610 may contain encoder 612 and decoder 616. Encoder 612 may consist of a neural network that transforms an input (e.g. LR resolution images 604) to a corresponding latent space representation 614 through an encoding process. Decoder 616 may consist of a neural network that transforms a latent space representation 614 to a corresponding reconstructed output (e.g. enhanced images 618) through a decoding process. The encoding process may involve performing one or more convolutions or downsampling operations to the original input data to produce intermediate representations, or feature maps, before finally arriving at latent space representation 614. The decoding process may involve performing one or more convolutions, transpose convolutions, or upsampling operations to latent space representation 614 to produce reconstructed feature maps before finally generating enhanced images 618.

“Convolutions” may involve applying filters or kernels to the input data, where each filter may capture specific local patterns or features from the input. The weights of these convolutional filters may be learned during training and may allow the model to focus on extracting the most relevant features. “Downsampling,” such as maxpooling or strided convolutions, may involve reducing the spatial dimensionality of the feature maps produced through convolutions by encoder 612. Downsampling operations may help aggregate information from previous layers of the neural network and reduce complexity. “Upsampling,” such as nearest neighbor interpolation or bilinear interpolation, may involve increasing the spatial dimensionality of the reconstructed feature maps produced by decoder 616.

In some embodiments, ML training pipeline 600 may train autoencoder 610 by optimizing the internal weights of autoencoder 610 against a loss function. In some embodiments, the loss function may include reconstruction loss. Reconstruction loss may refer to the difference between the final generated enhanced images 618 and the corresponding HR images 606. In some embodiments, reconstruction loss may be calculated by using mean-squared error. In some embodiments, additionally or alternatively, the loss function may include perceptual loss or adversarial loss 622. Perceptual loss may measure the difference between high-level features of enhanced images 618 and HR images 604, rather than pixel-level differences as in the case with reconstruction loss. In some embodiments, perceptual loss may be calculated using a pre-trained convolutional neural network including, but not limited to, VGG16 and VGG19. Including perceptual loss during training may be beneficial, as perceptual loss aims to capture and maintain perceptual and semantic details from a low-resolution image counterpart.

Adversarial loss 622 may be calculated by discriminating module 620. In some embodiments, discriminating module 620 may be a separate classifier model trained to distinguish between high resolution images 606 and enhanced images 618. In some embodiments, discriminating module 620 may be trained alongside autoencoder 610 and may provide feedback to autoencoder 610 on how realistic the generated enhanced images 618 are. The more realistic the enhanced images 618 produced by autoencoder 610, the harder it will be for discriminating module 620 to distinguish enhanced images 618 from high resolution images 606, and thus adversarial loss 622 may be minimized. By minimizing adversarial loss 622, autoencoder 610 may produce better quality enhanced images 618 that are likely to be successfully processed by a subsequent OCR process.

After selecting which one or more loss functions to use, ML training pipeline 600 may update the internal encoder and decoder weights of autoencoder 610 using backpropagation and optimization algorithms such as, but not limited to, stochastic gradient descent or Adam. After an iterative process, the final learned weights may capture the meaningful patterns and structures in LR images 604 and reconstruct accurate enhanced images 618.

FIG. 7 illustrates an example ML inference 700, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 7, as will be understood by a person of ordinary skill in the art.

Example ML inference 700 may include autoencoder 704, low resolution (LR) image 702, and high resolution (HR) image 724. Autoencoder 704 may be an example of autoencoder 610 (of FIG. 6) that has been trained. “Inference” may refer to the process of running new data points through a trained machine learning model to calculate outputs and/or predictions. For example, trained autoencoder 704 may perform a model inference by running LR image 702 through encoder 706 and decoder 716 to produce HR image 724.

In some embodiments, autoencoder 704 may employ encoder 706 to encode LR image 702 into a latent space representation 714. Latent space representation 714 may be a lower dimensional representation of image 702 that captures only the essential features and patterns of LR image 702. In some embodiments, encoder 706 may consist of one or more convolution layers 708(1)-(N), maxpool layer 710, and final convolution layer 712. In some embodiments, encoder 706 may apply one or more convolution layers 708(1)-(N) to LR image 702 to produce an initial feature map of LR image 702. Encoder 706 may then apply maxpool layer 710 to the initial feature map of LR image 702 to produce a downsampled feature map. Encoder 706 may then apply a final convolution layer (712) to the downsampled feature map to produce latent space representation 714.

In some embodiments, autoencoder 704 may employ decoder 716 to generate HR image 724 from latent space representation 714. In some embodiments, decoder 716 may consist of an initial transpose convolution layer 718, upsample layer 720, and one or more convolution layers 722(1)-(N). In some embodiments, decoder 716 may apply transpose convolution layer to latent space representation 714 to produce an upsampled feature map. Decoder 716 may then apply upsample layer 720 to produce a further upsampled feature map. Decoder 716 may then apply one or more convolution layers 722(1)-(N) to the further upsampled feature map to produce HR image 724.

Example architectures for autoencoder 704 will now be described. It is noted, however, that these examples are provided solely for illustrative purposes, and are not limiting. In a first non-limiting example, LR image 702 may be an RGB image 512px high and 512px wide. As such, the input image dimensions would be 512x512x3, since each pixel would contain a respect R, G, and B value. In this example, encoder 706 may employ two initial convolution layers 708(1) and 708(2). Convolution layer 708(1) may apply 32 filters of size 3x3 with stride 1. As described above, a “filter” may capture specific local patterns or features from an input image, typically through matrix multiplication. A “stride” may refer to the pixel length of the sliding window used when applying filters. Thus, a stride of 1 would signify that convolution layer 708(1) is applying a filter to each 3x3 subsection surrounding each pixel of LR image 702. As such, the output dimensions of convolution layer 708(1) would be 512x512x32.

After applying convolution layer 708(1), encoder 706 may apply convolution layer 708(2). Convolution layer 708(2) may apply 64 filters of size 3x3 with stride 1 to the output of convolution layer 708(1). As such, the output dimensions of convolution layer 708(2) may be 512x512x64. After applying convolution layer 708(2), encoder 706 may apply maxpool layer 710 to aggregate the 512x512x64 feature map data. Maxpool layer 710 may use a pooling size of 2x2 with stride 2 and produce a downsampled feature map with dimensions 256x256x64 (one-fourth the size of the output from convolution layer 708(2)). After applying maxpool layer 710, encoder 706 may apply final convolution layer 712. Convolution layer 712 may apply 128 filters of size 3x3 with stride 1 and produce a final feature map with dimensions 256x256x128. This final feature map may be flattened to produce a latent space representation 714 of size 8,388,608.

Decoder 716 may then perform a similar process in the reverse to generate HR image 724 from latent space representation 714. Decoder 716 may first reshape the flattened latent space representation 714 to produce feature map with dimensions 256x256x128. Decoder 716 may then apply transpose convolution layer 718 to the reshaped latent space representation. Transpose convolution layer 718 may apply 64 filters of size 3x3 with stride 1 and produce an upsampled feature map with dimensions 256x256x64. Decoder 716 may then apply upsample layer 720 with a 2x2 upsampling factor to further upsample the feature map produced by convolution layer 718 and produce an output with dimensions 512x512x64.

After producing the further upsampled feature map, decoder 716 may employ two convolution layers 722(1) and 722(2). Convolution layer 722(1) may apply 32 filters of size 3x3 and stride 1 and produce an output with dimensions 512x512x32. Finally, convolution layer 722(2) may apply 3 filters of size 3x3 and stride 1 to the output of convolution layer 722(1) and produce HR image 724, which should have the same dimensions as LR image 702, 512x512x3. By performing all of these operations, a subsequent OCR process may successfully extract the data fields from HR image 724 that were unable to be extracted by the previous OCR process.

In a second non-limiting example, LR image 702 may be a grayscale image 512px high and 512px wide. As such, the image input dimensions would be 512x512x1, as each pixel would contain a single grayscale value. In this example, encoder 706 may employ convolution layers 708(1) and 708(2), maxpool layer 710, and final convolution layer 712. Convolution layer 708(1) may apply 16 filters and produce an output of size 512x512x16. Convolution layer 708(2) may apply 32 filters and produce an output of size 512x512x32. Maxpool layer 710 may apply a pooling size of 4x4 and produce an output of size 128x128x32 (one-sixteenth the size of the output from convolution layer 708(2)). Final convolution layer 712 may apply 64 filters and produce an output of size 128x128x64. Fully flattened, this feature map corresponds to a latent space representation 714 of size 1,048,576.

In this example, decoder 716 may employ transpose convolution layer 718, upsample layer 720, and convolution layers 722(1) and 722(2). Decoder 716 may first reshape the flattened latent space representation 714 to an output of size 128x128x64. Then transpose convolution layer 718 may apply 32 filters and produce an output of size 128x128x32. Upsample layer 720 may upsample the feature map by a factor of 4x4 and produce an output of size 512x512x32. Convolution layer 722(1) may apply 16 filters and produce an output of size 512x512x16. Finally, convolution layer 722(2) may apply 1 filter and produce HR image 724, which should have dimensions 512x512x1.

In some embodiments, trained autoencoder 704 may be implemented on one or more processors of client device 302, cloud banking system 316, or a third party platform. In some embodiments, trained autoencoder 704 may be implemented on an edge server within cloud banking system 316.

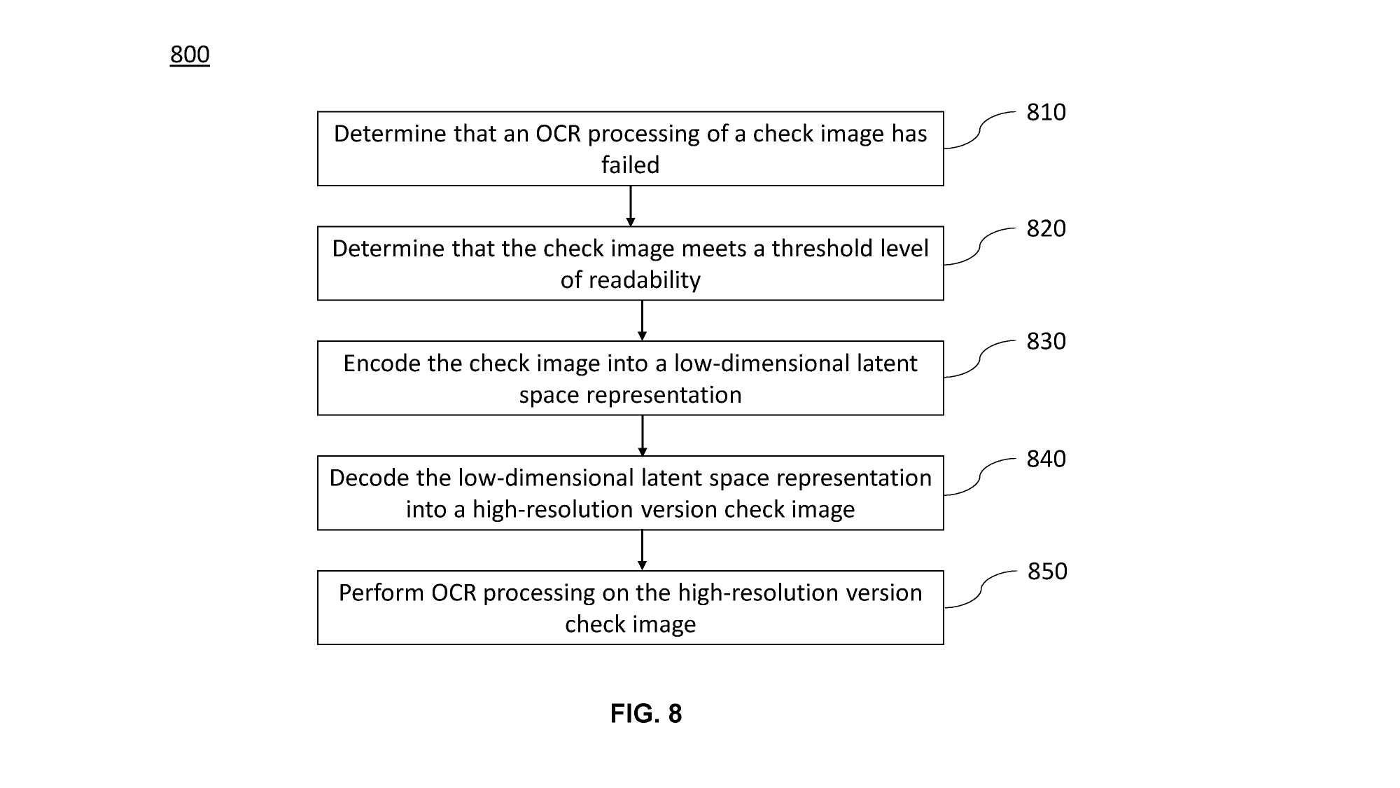

FIG. 8 is a flow chart depicting a method 800 that can be carried out in line with the discussion above. Method 800 shall be described with reference to FIGS. 3-7. However, method 800 is not limited to those example embodiments. One or more of the operations in the method depicted by FIG. 8 could be carried out by one or more entities, including, without limitation, client device 302, cloud banking system 316, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some embodiments, the systems described train and implement an autoencoder machine learning model for enhancing images in response to a failed OCR to increase the likelihood of a successful subsequent OCR to extract deposit data.

Unless stated otherwise, the steps of method 800 need not be performed in the order set forth herein. Additionally, unless specified otherwise, the steps of method 800 need not be performed sequentially. The steps may be performed in a different order or simultaneously. Further, method 800 may not include all the steps illustrated. For example, in some embodiments, method 800 may not include steps 810 and/or 820. In some embodiments, method 800 may not include step 810, for example, if the image enhancement process is continued regardless of whether OCR processing has failed or succeeded. In some embodiments, method 800 may not include step 820, for example, if the image enhancement process is continued regardless of whether the image does or does not meet a threshold level of readability.

Step 810 may include determining that an OCR processing of an image of a financial instrument received via a remote deposit environment has failed. For example, a user may submit an image of a check image to a remote deposit environment through mobile banking app 304. Mobile app server 332 or cloud banking system 316 may then initiate OCR processing on the submitted image but may be unsuccessful in extracting deposit data. As such, mobile app server 332 or cloud banking system 316 may determine that the OCR processing has failed.

In some embodiments, mobile app server 332 or cloud banking system 316 may employ a trained image classification ML model to predict if the received image would pass or fail OCR processing before any OCR processing is performed. In the event where the image classification ML model predicts the image as “fail”, mobile app server 332 or cloud banking system 316 may use this prediction to determine that an OCR processing has failed.

Step 820 may include determining, using a machine learning model, that the image of the financial instrument meets a threshold level of readability. In some embodiments, a trained image classification machine learning model may determine a readability score (e.g. readability score 516) indicating whether or not an image meets a threshold level of readability for enhancement. In some embodiments, a readability score may be above the threshold level of readability when enhancing an image may result in a successful subsequent OCR. For example, this may represent the scenario when the OCR processing has failed (or has been predicted to fail), but there is still sufficient structure in the image data that the data fields may be recovered (e.g. by a human eye or through the image enhancement process described herein). In some embodiments, a readability score may be below the threshold level of readability when enhancing an image may not result in a subsequent OCR (e.g. when the data in the image is completely unintelligible).

In some embodiments, one or more processors on client device 302, cloud banking system 316, or a third party platform may signal to the remote deposit environment to prompt a user to retake an image in response to the image not meeting a threshold level of readability for enhancement. Upon receiving an updated image, the remote deposit environment may reinitiate OCR processing to extract deposit data and perform image enhancement as needed.

Step 830 may include encoding the image into a low-dimensional latent space representation using an autoencoder machine learning model. For example, one or more processors on client device 302, cloud banking system 316, or a third party platform may employ a trained autoencoder 704 to enhance LR image 702. LR image 702 may be provided to trained autoencoder 704 in response to an unsuccessful OCR processing of a submitted image and the image meeting the threshold level of readability. In some embodiments, LR image 702 may be provided to trained autoencoder 704 without undergoing an initial OCR processing or image readability classification. In some embodiments, autoencoder 704 may employ encoder 706 to apply convolution layers 708(1)-(N) to LR image 702 to produce a feature map. Encoder 706 may then apply maxpool layer 710 to the feature map to produce a downsampled feature map. Encoder 706 may then apply a final convolution layer 712 to produce low-dimensional latent space representation 714.

Step 840 may include decoding the low-dimensional latent space representation into a high-resolution version of the image using the autoencoder machine learning model. For example, autoencoder 704 may employ decoder 716 to apply a transpose convolution layer 718 to the latent space representation 714 generated by encoder 706 and produce an upsampled feature map. Decoder 716 may then apply upsample layer 720 to the upsampled feature map and produce a further upsampled feature map. Decoder 716 may then apply convolution layers 722(1)-(N) to the further upsampled feature map and construct an HR image 724 that corresponds to LR image 702.

In some embodiments, the autoencoder machine learning model may be trained by optimizing against reconstruction loss between the true high resolution images and the generated high resolution images. In some embodiments, additionally or alternatively, the autoencoder machine learning model may be further trained by optimizing against a perceptual loss function or an adversarial loss function to further improve the resolution of reconstructed images during training.

Step 850 may include performing an OCR processing on the generated high-resolution version of the image to extract data fields. For example, mobile app server 332 or cloud banking system 316 may reinitiate OCR processing on HR image 724 to extract deposit data. Enhancing a low resolution image (e.g. LR image 702) by increasing resolution using an autoencoder provides a direct improvement over previous remote deposit systems, which would not have been able to properly process the low-resolution image and extract deposit data fields correctly.

While the above disclosure describes training and implementing predictive ML model(s) and autoencoder ML model(s) on images of financial instruments, this disclosure contemplates using images of any document that undergoes OCR processing as part of a data exchange process. For example, in some embodiments, the training and implementing of predictive ML model(s) and autoencoder ML model(s) to increase the chances of success of subsequent OCR processes may be used with documents such as identification documents (e.g., drivers licenses, passports, birth certificates, social security cards, etc.), with the same technical benefits. Successful OCR processing may be dependent upon a document type and purpose for submission of the document to a remote processing system. However, systems that implement OCR processing to extract data will have clear definitions of what constitutes successful OCR processing, such that the ideas of this disclosure may be applied broadly and consistently to various document types.

The solutions described above provide technical solutions to shortcomings of current remote deposit image capture processes. The various embodiments solve at least the technical problems associated with predicting in real-time, for example, prior to image upload and/or OCR processing, whether an image of a financial instrument will be able to be successfully processed to extract data necessary for execution of a transaction, resulting in a more efficient remote deposit process and user experience. The various embodiments encompassed by the technology disclosed herein are able to provide accurate predictions of OCR processing results mid-image capture experience, in some cases, before the customer completes the transaction, to avoid requiring the customer to wait to provide additional new image captures post extensive image quality checks or OCR processing. The various embodiments described herein also aid the user with easily and properly recapturing an image, which may be a technical shortcoming and user pain-point of existing systems.

Additionally, the solutions described above provide a means of quickly flagging financial instrument images that may pose a risk of fraud. For example, if a pixel-by-pixel comparison of a submitted check image to a collection of previously submitted images (e.g., using an ML model) shows little similarity to any previously submitted images, the submitted check image may be flagged as a potential fraud risk and further investigation may be performed.

### Example Computer System

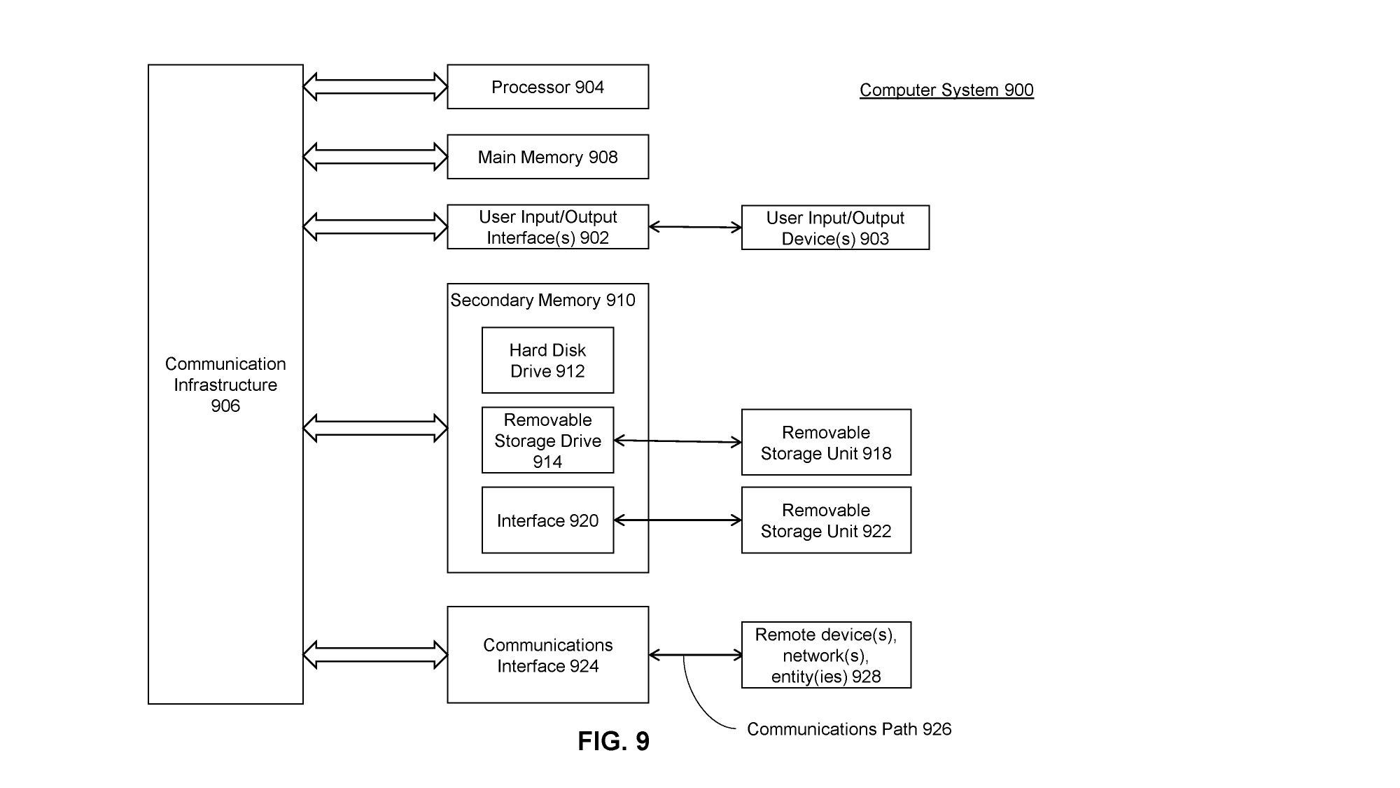

FIG. 9 depicts an example computer system useful for implementing various embodiments.

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof. For example, the example computer system may be implemented as part of mobile computing device 102, client device 302, cloud banking system 316, etc. Cloud implementations may include one or more of the example computer systems operating locally or distributed across one or more server sites.

Computer system 900 may include one or more processors (also called central processing units, or CPUs), such as a processor 904. Processor 904 may be connected to a communication infrastructure or bus 906.

Computer system 900 may also include customer input/output device(s) 902, such as monitors, keyboards, pointing devices, etc., which may communicate with communication infrastructure 906 through customer input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 916. Removable storage unit 916 may include a computer usable or readable storage device having stored thereon computer software (control logic) and/or data. Removable storage unit 916 may be a floppy disk, magnetic tape, compact disk, DVD, optical storage disk, and/ any other computer data storage device. Removable storage drive 914 may read from and/or write to removable storage unit 916.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 916 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The breadth and scope of the present disclosure should not be limited by any of the above-described exemplary embodiments, but should be defined only in accordance with the following claims and their equivalents.

What is claimed is:

1. A computer implemented method for a remote deposit environment, comprising:
determining that an optical character recognition (OCR) processing of an image of a financial instrument received via a remote deposit environment has failed;
determining, using a machine learning model, that the image of the financial instrument meets a threshold level of readability;
encoding the image into a low-dimensional latent space representation using an autoencoder machine learning model;
decoding the low-dimensional latent space representation into an image that meets a resolution threshold using the autoencoder machine learning model; and
performing an OCR processing on the image that meets the resolution threshold to extract data fields.

2. The computer implemented method of claim 1, wherein training the autoencoder machine learning model comprises:
collecting a plurality of images of financial instruments that meet the resolution threshold;
downsampling the plurality of images that meet the resolution threshold to create a plurality of corresponding images that do not meet the resolution threshold; and
training the autoencoder machine learning model using the plurality of images that meet the resolution threshold and the plurality of corresponding images that do not meet the resolution threshold.

3. The computer implemented method of claim 1, wherein the encoding the image comprises:
applying one or more convolutional layers to the image to produce an initial feature map;
applying a max pooling layer to the feature map to produce a downsampled feature map;
applying a final convolutional layer to the downsampled feature map to produce the low-dimensional latent representation of the image.

4. The computer implemented method of claim 1, wherein the decoding the low-dimensional latent space representation comprises:
applying a transposing convolutional layer to the low-dimensional latent space representation to produce an upsampled feature map;
applying an upsampling layer to the upsampled feature map to produce a further upsampled feature map;
applying one or more convolutional layers to the further upsampled feature map to construct the image that meets the resolution threshold.

5. The computer implemented method of claim 2, further comprising:
optimizing against a perceptual loss function to improve a resolution of reconstructed images during training.

6. The computer implemented method of claim 2, further comprising:
optimizing against an adversarial loss function to improve a resolution of reconstructed images during training.

7. The computer implemented method of claim 1, further comprising:
in response to determining that the image does not meet the threshold level of readability, signaling to the remote deposit environment to prompt a user to retake the image.

8. A system, comprising:
at least one memory; and
at least one processor coupled to the at least one memory and configured to perform operations comprising:
determining that an optical character recognition (OCR) processing of an image of a financial instrument received via a remote deposit environment has failed;
determining, using a machine learning model, that the image of the financial instrument meets a threshold level of readability;
encoding the image into a low-dimensional latent space representation using an autoencoder machine learning model;
decoding the low-dimensional latent space representation into an image that meets a resolution threshold using the autoencoder machine learning model; and
performing an OCR processing on the image that meets the resolution threshold to extract data fields.

9. The system of claim 8, wherein training the autoencoder machine learning model comprises:
collecting a plurality of images of financial instruments that meet the resolution threshold;
downsampling the plurality of images that meet the resolution threshold to create a plurality of corresponding images that do not meet the resolution threshold; and
training the autoencoder machine learning model using the plurality of images that meet the resolution threshold and the plurality of corresponding images that do not meet the resolution threshold.

10. The system of claim 8, wherein the encoding the image comprises:
applying one or more convolutional layers to the image to produce an initial feature map;
applying a max pooling layer to the feature map to produce a downsampled feature map;
applying a final convolutional layer to the downsampled feature map to produce the low-dimensional latent representation of the image.

11. The system of claim 8, wherein the decoding the low-dimensional latent space representation comprises:
applying a transposing convolutional layer to the low-dimensional latent space representation to produce an upsampled feature map;
applying an upsampling layer to the upsampled feature map to produce a further upsampled feature map;
applying one or more convolutional layers to the further upsampled feature map to construct the image that meets the resolution threshold.

12. The system of claim 9, the operations further comprising:
optimizing against a perceptual loss function to improve a resolution of reconstructed images during training.

13. The system of claim 9, the operations further comprising:
optimizing against an adversarial loss function to improve a resolution of reconstructed images during training.

14. The system of claim 8, the operations further comprising:
in response to determining that the image does not meet the threshold level of readability, signaling to the remote deposit environment to prompt a user to retake the image.

15. A non-transitory computer-readable device having instructions stored thereon that, when executed by at least one computing device, causes the at least one computing device to perform operations comprising:
determining that an optical character recognition (OCR) processing of an image of a financial instrument received via a remote deposit environment has failed;
determining, using a machine learning model, that the image of the financial instrument meets a threshold level of readability;
encoding the image into a low-dimensional latent space representation using an autoencoder machine learning model;
decoding the low-dimensional latent space representation into an image that meets a resolution threshold using the autoencoder machine learning model; and
performing an OCR processing on the image that meets the resolution threshold to extract data fields.

16. The non-transitory computer-readable medium of claim 15, wherein training the autoencoder machine learning model comprises:
collecting a plurality of images of financial instruments that meet the resolution threshold;
downsampling the plurality of images that meet the resolution threshold to create a plurality of corresponding images that do not meet the resolution threshold; and
training the autoencoder machine learning model using the plurality of images that meet the resolution threshold and the plurality of corresponding images that do not meet the resolution threshold.

17. The non-transitory computer-readable medium of claim 15, wherein the encoding the image comprises:
applying one or more convolutional layers to the image to produce an initial feature map;
applying a max pooling layer to the feature map to produce a downsampled feature map;
applying a final convolutional layer to the downsampled feature map to produce the low-dimensional latent representation of the image.

18. The non-transitory computer-readable medium of claim 15, wherein the decoding the low-dimensional latent space representation comprises:
applying a transposing convolutional layer to the low-dimensional latent space representation to produce an upsampled feature map;
applying an upsampling layer to the upsampled feature map to produce a further upsampled feature map;
applying one or more convolutional layers to the further upsampled feature map to construct the image that meets the resolution threshold.

19. The non-transitory computer-readable medium of claim 16, the operations further comprising:
optimizing against a perceptual loss function to improve a resolution of reconstructed images during training.

20. The non-transitory computer-readable medium of claim 16, the operations further comprising:
optimizing against an adversarial loss function to improve a resolution of reconstructed images during training.
